(19) United States
(12) Patent Application Publication
(10) Pub. No.: US 2003/0072935 A1
(43) Pub. Date: Apr. 17, 2003

(54) Porous resin film

(75) Inventors: Yasuo Iwasa, Ibaraki (JP); Seiichiro Iida, Ibaraki (JP); Nobuhiro Shibuya, Ibaraki (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: YUPO CORPORATION, Chiyoda-ku (JP)

(21) Appl. No.: 10/159,112

(22) Filed: Jun. 3, 2002

Related U.S. Application Data
(63) Continuation of application No. PCT/JP00/08435, filed on Nov. 29, 2000.

(30) Foreign Application Priority Data
Dec. 1, 1999 (JP) P. HEI. 11-342129
Mar. 14, 2000 (JP) 2000-069740
May 26, 2000 (JP) 2000-156093

(51) Int. Cl. B32B 3/26; B32B 5/22

(52) U.S. Cl. 428/317.9; 428/305.5

(57) ABSTRACT

A porous resin film containing a thermoplastic resin, an inorganic and/or organic finely divided powder and a hydrophilicizer, and having a liquid absorption capacity of not smaller than 0.5 ml/m² may be incorporated in a recording medium to provide good absorption of water present as a solvent for aqueous ink or aqueous paste and ink absorption without density unevenness during solid printing of large amounts of ink during ink jet recording.

### BACKGROUND OF THE INVENTION

1. Field of the Invention

The present invention relates to a porous resin film which has excellent aqueous liquid absorbency and ink absorbency properties. The present invention also relates to a recording medium which exhibits particularly good ink jet recording properties and thus allows the formation of a fine image.

2. Discussion of the Background

Film-based synthetic papers comprising a resin as a main component and having excellent water resistance have heretofore been mainly used for offset printing or seal printing using an oil-based ink or UV curing ink, or sublimation or melt type heat transfer, etc. However, as film-based synthetic paper has found more application, there has been a growing demand for adaptability to printing methods using an aqueous ink and aqueous paste for environmental protection. To this end, a synthetic paper has been needed having good absorption of aqueous ink, aqueous paste or water content which acts as a solvent therefor.

Further, with the recent progress of multimedia techniques, ink jet processes, and printers have spread in business or consumer use. The ink jet process printer can be used for multi-color displays and large-sized images thus providing reduced printing cost. In particular, an ink jet printer utilizing an aqueous ink, which has fewer environmental or safety problems as compared with oil-based ink, has been popular recently.

The ink jet printer has been widely used as a means for obtaining a hard copy containing characters as well as for image processing. Therefore, the image formed after printing is required to have a greater fineness. The fineness of image depends on the dryability of the ink printed on the recording medium. For example, in the case where printing is repeatedly made on a plurality of sheets of a recording medium, other sheets of recording medium may be placed on the recording medium which has already received ink. If the sheet of recording medium which has received ink does not sufficiently absorb the ink, the ink can transfer to the other sheets placed thereon, causing image stain.

In order to enhance the fineness of image, a method has been widely employed which comprises coating an ink-receptive material containing a hydrophilic resin or inorganic finely divided powder onto a recording medium such as plastic film or paper (Japanese Patent Laid-Open No. 1992-82589, Japanese Patent Laid-Open No. 1997-216456). On the other hand, a recording medium for ink jet recording having an ink-receptive layer mainly composed of a hydrophilic resin formed by a heat lamination method or extrusion lamination method has been proposed (Japanese Patent Laid-Open No. 1995-12871, Japanese Patent Laid-Open No. 1997-1920). However, the recording media for ink jet recording formed by these methods have disadvantages in that when the amount of ink is great, they may not be capable of absorbing the ink, requiring that the thickness of the coating layer be increased and hence requiring a plurality of coating steps.

### SUMMARY OF THE INVENTION

Accordingly, an object of the present invention is to solve the problems of the related art techniques. In other words, an object of the present invention is to provide a porous resin film having good absorption of water content used as the solvent for aqueous ink or aqueous paste and a recording medium which can absorb an ink without density unevenness even if the amount of ink is great, i.e., solid printing or the like is effected, in ink jet recording processes. Another object of the present invention is to provide a porous resin film constituting such a recording medium having excellent properties.

### DISCLOSURE OF THE INVENTION

The inventors have conducted extensive studies for the purpose of solving the aforementioned problems. As a result, it was found that a porous resin film comprising a thermoplastic resin, an inorganic and/or organic finely divided powder and a hydrophilicizer, and having a liquid absorption capacity of not smaller than 0.5 ml/m2 as measured by “Japan TAPPI No. 51-87” exhibits a good aqueous liquid absorbency and, when it has a surface contact angle of not greater than 110°, can absorb an ink without density unevenness even if the amount of ink is great and thus can be used as a recording medium for ink jet recording or the like.

In other words, the present invention provides a porous resin film comprising a thermoplastic resin, an inorganic and/or organic finely divided powder and a hydrophilicizer, and having a liquid absorption capacity of not smaller than 0.5 ml/m² as measured by “Japan TAPPI No. 51-87”, and in a preferred embodiment, the average contact angle of the film with respect to water is not greater than 110°, and more preferably, the porous resin film is one having pores in the surface and the interior thereof and has a porosity of not smaller than 10%.

The thermoplastic resin is preferably a polyolefin-based resin, and the inorganic finely divided powder or organic finely divided powder preferably has an average particle diameter of from 0.01 μm to 20 μm. Further, the specific surface area of the inorganic finely divided powder or organic finely divided powder is preferably not smaller than 0.5 m²/g.

Referring to a preferred embodiment of the mixing proportion of the constituents, the sum of the amount of the thermoplastic resin and the hydrophilicizer is from 30 to 90% by weight, the amount of the inorganic finely divided powder or organic finely divided powder is from 10 to 70% by weight, and the amount of the hydrophilicizer based on 100 parts by weight of the thermoplastic resin falls within a range of from 0.01 μm to 20 μm.

The hydrophilicizer preferably exhibits a surface tension of 25 mN/m when measured as a 0.01% aqueous solution, and specific preferred examples of the hydrophilicizer include sodium or potassium salts of sulfonic acid having a C₄-C₄₀ hydrocarbon group, alkyl betain or alkyl sulfobetain having a C₄-C₃₀ hydrocarbon group, and ammonium compounds having at least one C₄-C₄₀ hydrocarbon group, and the amount of the hydrophilicizer to be used is from 0.01 to 50 parts by weight based on 100 parts by weight of the sum of the amount of the thermoplastic resin and the inorganic finely divided powder or organic finely divided powder.

In a further preferred embodiment, the porous resin film is stretched. The present invention includes a laminate comprising a porous resin film provided on at least one surface thereof and also includes a recording medium comprising such a laminate and further includes an ink jet recording medium comprising an ink-receptive layer provided thereon.

The ink-receptive layer preferably comprises an inorganic filler having an average particle diameter of not greater than 350 nm and a binder resin incorporated therein in an amount of from 70 to 95% by weight and from 5 to 30% by weight, respectively. Further, the inorganic filler is preferably an amorphous silica and/or alumina and/or alumina hydrate, and in particular, the amorphous silica is obtained by agglomerating primary particles having an average diameter of from 1 nm to 10 nm. Moreover, the amorphous silica is preferably a cationically treated silica.

The alumina is, preferably 8-alumina, and the alumina hydrate is preferably pseudo-boehmite.

Further, in the present invention, the ink-receptive layer preferably comprises a crosslinking agent and an ink fixing agent incorporated therein each in an amount of from 1 to 20% by weight.

Moreover, in the present invention, a top coat layer is preferably further provided on the ink-receptive layer, and the surface gloss of the top coat layer is preferably not smaller than 50% (as measured at 60° according to JIS-Z8741). The top coat layer preferably comprises an inorganic filler having an average particle diameter of not greater than 350 nm and a binder resin incorporated therein in an amount of from 70 to 95% by weight and from 5 to 30% by weight, respectively.

### DESCRIPTION OF THE PREFERRED EMBODIMENTS

The porous resin film and recording medium of the invention will be further described hereinafter.

The liquid absorption capacity of the porous resin film of the invention is not smaller than 0.5 ml/m², preferably from 3 to 2,600 ml/m², more preferably from 5 to 100 m/m².

When the liquid absorption capacity of the porous resin film falls below 0.5 ml/m², 20 the porous resin film exhibits an insufficient absorption of aqueous ink and aqueous paste. Further, since it is also necessary that the thickness of the porous resin film be taken into account to increase the absorption, the upper limit of the liquid absorption capacity is properly predetermined depending on the purpose.

The liquid absorption capacity of the porous resin film of the invention is measured according to “Japan TAPPI No. 51-87” (JAPAN TAPPI, paper pulp testing method No. 51-87; Bristow Method). In the present invention, the value measured in 2 seconds of absorption time is defined as liquid absorption capacity. As the solvent to be used in the measurement there is used one obtained by adding a coloring dye to 100% by weight of a mixture of 70% by weight of water and 30% by weight of ethylene glycol. As the coloring dye there is used malachite green or the like in an amount of about 2 parts by weight based on 100 parts by weight of the mixed solvent, but the kind and amount of the coloring dye to be used is not specifically limited so far as they don't change drastically the surface tension of the solvent to be used in the measurement.

As the measuring instrument there may be used, e.g., a liquid absorbency testing machine produced by Kumagai Riki Kogyo K. K.

The greater the liquid absorption capacity per absorption time is, the less likely it is that an aqueous paste can come out from the edge of paper. In the present invention, the liquid absorption capacity in 40 milliseconds is preferably not smaller than 0.8 ml/m², more preferably from 1 to 500 ml/M².

Further, the greater the liquid absorption speed as measured above, the better the results of absorption by and drying of the color-imposed area. In the present invention, the absorption speed between 20 milliseconds to 400 milliseconds is normally not smaller than 0.02 ml/{m²·(ms)^{½}}, preferably from 0.1 to 100 ml/{m²·(ms)^{½}}.

The surface contact angle of the porous resin film of the present invention with respect to water is not greater than 110°, preferably from 0 to 100°, more preferably from 0 to 90°.

When the surface contact angle of the porous resin film exceeds 110°, the penetration of a liquid such as paste comprising an aqueous ink or aqueous medium is not sufficient. From the standpoint of the requirements that the spread of an aqueous ink droplet in the direction parallel to the surface of film and the penetration of the aqueous ink droplet into the film in the thickness direction be balanced, there is a proper range of contact angle, and the contact angle is properly predetermined according to the kind of the ink.

The surface contact angle of the film of the invention with respect to water is measured by dropping purified water onto the surface of the film, and then measuring the contact angle of the film after 1 minute. Ten measurements are made on one specimen. Once measured, the specimen is replaced by an unmeasured specimen which is not yet wet with purified water for measurement of contact angle. These measurements are then averaged to determine the contact angle with water. An example of commercially available contact angle meter which can be used to measure the contact angle of the present invention is a Type CA-D contact angle meter produced by KYOWA INTERFACE SCIENCE CORPORATION LIMITED.

Further, the smaller the “difference between maximum value and minimum value” in the ten measurements of contact angle is, the more uniform tends to be the absorption of the ink or the liquid comprising an aqueous medium and the better is the print quality given by the printing medium. By way of example, the difference between maximum value and minimum value is not greater than 40°, preferably not greater than 30°, more preferably not greater than 20°.

The porous resin film of the present invention has fine pores in the surface thereof and absorbs an aqueous ink or aqueous liquid in contact with the surface thereof through the pores. The number and shape of the pores in the surface of the porous resin film can be determined by observation under an electron microscope.

The shape of pores in the surface of the porous resin film can be observed by cutting an arbitrary part out of the porous resin film specimen, sticking the specimen to an observation specimen carrier, vacuum-evaporating gold, gold-palladium or the like onto the surface of the specimen to be observed, and then observing the specimen under a Type S-2400 scanning electron microscope produced by HITACHI LTD. or the like at any magnification power allowing easy observation to know the number, size and shape of pores. The number of pores at an area within a field of view to be observed is calculated in terms of unit area to determine the number of pores.

The number of pores per unit area on the surface of the porous resin film needs to be not smaller than 1×10⁶/m², preferably not smaller than 1×10⁷/m², more preferably not smaller than 1×10⁸/m² from the standpoint of enhancement of absorption of aqueous liquid.

Further, from the standpoint of enhancement of surface strength to a higher level, it is preferably not greater than 1×110⁵/m², more preferably not greater than 1×10¹²/m².

The shape of pores in the vicinity of the surface of the porous resin film varies and may be circular and ellipsoidal, and the average [(L+M)/2] of measurements of the maximum diameter (L) of each of the pores and the maximum diameter (M) in the direction perpendicular thereto is defined to be the average diameter of the pore. The measurement is repeatedly made on at least 15 surface pores, and the average of the measurements is defined to be the average diameter of pores in the surface of the porous resin film of the invention. Preferably, the measurement is made on at least 20 surface pores, and the average of the measurements is defined to be the average diameter of pores. From the standpoint of enhancement of liquid absorbency to a higher level, the average diameter is preferably not smaller than 0.01 μm, more preferably not smaller than 0.1 μm, even more preferably not smaller than 1 μm. In order to enhance the surface strength of the porous resin film to a higher level, the average diameter is not greater than 50 μm, preferably not greater than 30 μm, more preferably not greater than 20 μm.

The porous resin film of the invention has a porous structure having fine pores in the interior thereof, and from the standpoint of enhancement of absorption and dryability of aqueous ink, the porosity thereof is not smaller than 10%, preferably from 20 to 75%, more preferably from 30 to 65%. When the porosity is not greater than 75%, the strength of the film material is on a good level.

The presence of pores in the interior of the porous resin film can be confirmed by observing the section of the film under an electron microscope.

The porosity in the present description indicates the porosity represented by the following equation (1) or the percent area proportion (%) of pores in the region on the section observed under an electron microscope. The porosity represented by the following equation (1) and the area proportion are the same as each other. In some detail, the porous resin film is embedded in an epoxy resin which is then solidified, cut by a microtome so that sections are formed in the direction parallel to the thickness direction and in the direction perpendicular to the surface of the film, respectively, metallized on the sections, and then observed on the sections at an arbitrary power of magnification allowing easy observation, e.g., from 50 to 2,000. By way of example, the region thus observed is taken in picture. The picture of pores is then traced to a tracing film. The drawing obtained by smearing away the area of pores can then be image-processed by an image analyzer (LUZEX IID, produced by NIRECO CORPORATION) to determine the percent area of pores from which the porosity can be calculated. In the case of a laminate having a porous resin film of the present invention provided on the surface thereof, the thickness and basis weight of the porous resin film of the present invention are calculated from the thickness and basis weight (g/m²) of the laminate and the portion obtained by excluding the porous resin film of the present invention from the laminate to determine the density (ρ). Further, the density (ρ₀) of the nonporous portion is determined from the formulation of the constituents. Then, the porosity can be determined by the following equation (1).

Porosity (%)=100 (ρ₀−ρ)/ρ₀ (1)

ρ₀: Density of nonporous portion of porous resin film,

ρ: Density of porous resin film

Further, the shape or dimension of the internal pores can be observed at a power of magnification allowing easy observation under a scanning electron microscope, e.g., 500 to 2,000. The dimension of the internal pores is determined by averaging the measurements of dimension of at least 10 internal pores in the surface direction and thickness direction.

The average dimension of the pores in the porous resin film in the surface direction is from 0.1 μm to 1,000 μm, preferably from 1 μm to 500 μm. From the standpoint of enhancement of the mechanical strength of the porous resin film to a higher level, the maximum dimension of the pores in the surface direction is preferably not greater than 1,000 μm. Further, from the standpoint of enhancement of absorbency of aqueous liquid to a higher level, the maximum dimension of the pores in the surface direction is preferably not smaller than 0.1 μm.

The average dimension of the pores in the porous resin film in the thickness direction is normally from 0.01 μm to 50 μm, preferably from 0.1 μm to 10 μm. From the standpoint of enhancement of absorbency of aqueous liquid, the dimension of the pores in the thickness direction is preferably greater, but the upper limit of the dimension of the pores in the thickness direction can be predetermined depending on the purpose to provide the film with a proper mechanical strength.

The porous resin film of the present invention comprises in combination a thermoplastic resin, an inorganic finely divided powder and/or an organic finely divided powder, and a hydrophilicizer as constituent components. Examples of the thermoplastic resin to be used in the porous resin film of the present invention include ethylene-based resin such as high density polyethylene, middle density polyethylene and low density polyethylene, polyolefin-based resin such as polymethyl-1-pentene and ethylene-cyclic olefin copolymer, polyamide-based resin such as nylon-6, nylon-6,6, nylon-6,10 and nylon-6,12, thermoplastic polyester-based resin such as polyethylene terephthalate, copolymer thereof, polyethylene naphthalate and aliphatic polyester, and thermoplastic resin such as polycarbonate, atactic polystyrene, syndiotactic polystyrene and polyphenylene sulfide. Two or more of these thermoplastic resins may be used in admixture.

Preferred among these thermoplastic resins is an ethylene-based resin or a polyolefin-based resin such as propylene-based resin, more preferably propylene-based resin from the standpoint of chemical resistance, low specific gravity, cost, etc. Examples of the propylene-based resin include isotactic polymer or syndiotactic polymer obtained by homopolymerization of propylene. Alternatively, a copolymer comprising as main component a propylene homopolymer having various stereoregularities obtained by the copolymerization of a-olefin such as ethylene, 1-butene, 1-hexene, 1-heptene and 4-methyl-1-pentene with propylene may be used. The copolymer may be in the form of binary or ternary or higher system or may be either a random copolymer or a block copolymer. The propylene-based resin preferably comprises a resin having a melting point lower than that of propylene homopolymer incorporated therein in an amount of from 2 to 25% by weight. Examples of such a resin having a low melting point include high density or low density polyethylene.

The kind of the organic or inorganic finely divided powder to be used in the porous resin film of the present invention is not specifically limited, but specific examples of the organic or inorganic finely divided powder will be given below.

Examples of the inorganic finely divided powder include heavy calcium carbonate, light calcium carbonate, agglomerated light calcium carbonate, silica having various pore volumes, zeolite, clay, talc, titanium oxide, barium sulfate, zinc oxide, magnesium oxide, diatomaceous earth, silicon oxide, composite inorganic finely divided powder having a hydroxyl group-containing inorganic finely divided powder such as silica as nucleus surrounded by an aluminum oxide or hydroxide, etc. Among these inorganic finely divided powders, heavy calcium carbonate, clay and diatomaceous earth are preferably used because they are inexpensive and have good pore-forming properties if the film is stretched. The organic finely divided powder is selected from non-compatible organic finely divided powders having a higher melting point or glass transition point than that of the thermoplastic resin to be used in the porous resin film of the present invention for the purpose of forming pores. Specific examples of the organic finely divided powder include polyethylene terephthalate, polybutylene terephthalate, polyamide, polycarbonate, polyethylene naphthalate, polystyrene, polymer or copolymer of acrylic acid ester or methacrylic acid ester, melamine resin, polyethylene sulfite, polyimide, polyethyl ether ketone, polyphenylene sulfide, homopolymer of cyclic olefin, copolymer of cyclic olefin with ethylene, etc. An organic finely divided powder having a melting point of from 120° C. to 300° C. or a glass transition temperature of from 120° C. to 280° C. is preferably used.

Preferred among inorganic finely divided powder and organic finely divided powder is inorganic finely divided powder because it generates little amount of heat when combusted.

The average particle diameter of the inorganic finely divided powder or organic finely divided powder to be used in the present invention is preferably from 0.01 μm to 20 μm, more preferably from 0.1 μm to 10 μm, even more preferably from 0.5 μm to 10 μm. The average particle diameter of the inorganic finely divided powder or organic finely divided powder is preferably not smaller than 0.01 μm from the standpoint of ease of mixing with the thermoplastic resin. In the case where the porous resin film is stretched to form pores in the interior thereof, enhancing the absorbency thereof, the average particle diameter of the inorganic finely divided powder or organic finely divided powder is preferably not greater than 20 μm from the standpoint of difficulty in the occurrence of troubles such as sheet breakage and deterioration of strength of surface layer during stretching.

The particle diameter of the inorganic finely divided powder or organic finely divided powder to be used in the present invention can be determined by the particle diameter corresponding to 50% of cumulation of particle diameter (50% cumulative particle diameter) measured by a particle diameter meter, e.g., laser diffraction type particle diameter meter “Microtrack” (produced by NIKKISO CO., LTD.). Further, the particle diameter of finely divided powder dispersed in the thermoplastic resin by melt kneading and dispersion can be determined as an average value by measuring at least 10 particles on the section of the porous resin film under an electron microscope.

The specific surface area of the inorganic finely divided powder or organic finely divided powder to be used in the present invention is measured by BET method and is, by way of example, preferably from 0.1 to 1,000 m²/g, more preferably from 0.2 to 500 m²/g, even more preferably from 0.5 to 100 m²/g.

When an inorganic finely divided powder or organic finely divided powder having a large specific surface area is used, it tends to improve the absorption of an aqueous solvent or ink. Further, in the case where the mixing and dispersion with the hydrophilic thermoplastic resin or non-hydrophilic thermoplastic resin tends to cause troubles such as insufficient dispersion due to classification and foaming due to entrained air, the upper limit of specific surface area suitable for use is properly predetermined. Moreover, inorganic or organic finely divided powders having various oil absorptions can be used, and by way of example, the oil absorption (JIS K5 101-1991, etc.) of the inorganic or organic finely divided powder is from 1 to 300 ml/100 g, preferably from 10 to 200 ml/g.

As the organic finely divided powder or inorganic finely divided powder to be used in the porous resin film of the invention there may be singly selected and used one among those described above or selected or used in combination two or more among those described above. In the case where two or more of inorganic or organic finely divided powders are used in combination, an organic finely divided powder and an inorganic finely divided powder may be used in combination.

The hydrophilicizer to be used in the present invention has a surface tension of not smaller than 25 mN/m (dyn/cm), preferably from 25 to 70 mN/m, even more preferably from 30 to 65 mN/m as measured in its 0.01% aqueous solution by Du-Nouy method. From the standpoint of improvement of the absorption of aqueous solvent or aqueous ink by the porous resin film, when the surface tension of the hydrophilicizer is not smaller than 25 mN/m, it exerts a greater effect. Alternatively, from the standpoint of balance between the penetration of aqueous solvent into the porous resin film in the thickness direction and the spread of aqueous solvent over the film in the surface direction, the surface tension of the hydrophilicizer is preferably not greater than 70 mN/m in some cases.

The molecular weight of the hydrophilicizer is not specifically limited, but there are some cases where its selection can make the mixing with other components more uniform or improve the absorption of these components. By way of example, the molecular weight of the hydrophilicizer is not greater than 20,000, preferably from 100 to 3,000, more preferably from 150 to 1,000.

Specific examples of the hydrophilicizer will be given below.

In other words, there may be used the following compounds:

(K) Sulfonate having a hydrocarbon group having from 4 to 40 carbon atoms;

(L) Phosphoric acid ester salt having a hydrocarbon group having from 4 to 40 carbon atoms, phosphoric acid mono- or diester salt of higher alcohol having from 4 to 40 carbon atoms, phosphoric acid ester salt of ethylene oxide adduct of higher alcohol having from 4 to 40 carbon atoms;

(M) Higher aliphatic alcohol, alkyl phenol, higher aliphatic amine or ethylene oxide adduct of higher aliphatic acid amide with from 4 to 40 carbon atoms having a molecular weight of not greater than about 3,000;

(N) Alkylbetaine or alkylsulfobetaine having a hydrocarbon group having from 4 to 40 carbon atoms;

(P)N-alkyl-α-, β- and γ-amino acid salt having an alkyl group having from 4 to 30 carbon atoms on nitrogen atom; and

(O) Ammonium compound having at least one hydrocarbon group having from 4 to 40 carbon atoms.

The term “salt” as used hereinabove and hereinafter indicates lithium salt, sodium salt, potassium salt, calcium salt, magnesium salt, primary to quaternary ammonium salt or primary to quaternary phosphonium salt. Preferred among these salts are lithium salt, sodium salt, potassium salt, and quaternary ammonium salt, more preferably sodium salt or potassium salt.

(K) Examples of the sulfonate having a hydrocarbon group having from 4 to 40 carbon atoms include mono-, di- and polysulfonate and sulfoalkane carboxylate having a hydrocarbon group having a straight-chain, branched or cyclic structure having from 4 to 40, preferably from 8 to 20 carbon atoms. Specific examples of these compounds include alkylbenzenesulfonate and naphthalenesulfonic acid salt having from 4 to 40, preferably from 8 to 20 carbon atoms, alkylnaphthalenesulfonic acid salt having a straight-chain, branched or cyclic structure having from 4 to 30, preferably from 8 to 20 carbon atoms, monosulfonate or disulfonate of diphenylether or biphenyl having an alkyl group having a straight-chain or branched structure having from 1 to 30, preferably from 8 to 20 carbon atoms, alkanesulfonic acid salt having a straight-chain or branched structure having from 1 to 30, preferably from 8 to 20 carbon atoms, alkylsulfuric acid ester salt having from 1 to 30, preferably from 8 to 20 carbon atoms, sulfoalkanecarboxylic acid ester salt, etc.

Specific examples of these compounds include alkanesulfonic acid or aromatic sulfonic acid, i.e., octanesulfonic acid salt, dodecanesulfonic acid salt, hexadecanesulfonic acid salt, octadecanesulfonic acid salt, or 2-dodecylbenzenesulfonic acid salt, 1- or 2-hexadecylbenzenesulfonic acid salt, 1- or 2-octadecylbenzenesulfonic acid salt, various isomers of naphthalenesulfonic acid salt, various isomers of dodecylnaphthalenesulfonic acid salt, β-naphthalenesulfonic acid-formalin condensate salt, various isomers of octylbiphenylsulfonic acid salt, dodecylbiphenylsulfonic acid salt, various isomers of dodecylphenoxybenzenesulfonic acid salt, dodecyldiphenylether disulfonic acid salt, dodecyl lignin sulfonic acid salt, alkylsulfuric acid ester salt, i.e., dodecylsulfuric acid salt, hexadecylsulfuric acid salt, sulfoalkanecarboxylic acid salt, i.e., sulfosuccinic acid dialkylester the alkyl moiety of which has a straight-chain, branched or cyclic structure having from 1 to 30, preferably from 4 to 20 carbon atoms, e.g., sulfosuccinic acid di(2-ethylhexyl) salt, N-methyl-N-(2-sulfoethyl)alkylamide salt (alkyl group has from 1 to 30, preferably from 12 to 18 carbon atoms) (e.g., amide compound derived from N-methyltaurin and oleic acid), 2-sulfoethylester salt of carboxylic acid having from 1 to 30, preferably from 10 to 18 carbon atoms, laurylsulfuric acid triethanolamine, laurylsulfuric acid ammonium, polyoxyethylene laurylsulfuric acid salt, polyoxyethylene cetylsulfiric acid salt, etc.

(L) Phosphoric acid mono- or diester salt or phosphoric acid triester having a hydrocarbon group having a straight-chain, branched or cyclic structure having from 4 to 40, preferably from 8 to 20 carbon atoms. Specific examples of such a compound include phosphoric acid dodecyl disodium salt or dipotassium salt, phosphoric acid hexadecyl disodium salt or dipotassium salt, phosphoric acid didodecyl disodium salt or potassium salt, phosphoric acid dihexadecyl sodium salt or potassium salt, phosphoric acid triester of ethylene oxide adduct of dodecyl alcohol, etc.

(M) Higher aliphatic alcohol, alkyl phenol, higher aliphatic amine or ethylene oxide adduct of higher aliphatic acid amide with from 4 to 40 carbon atoms having a molecular weight of not greater than about 3,000. Specific examples of such a compound include ethylene oxide adduct of lauryl alcohol, ethylene oxide adduct of cetyl alcohol, ethylene oxide adduct of stearyl alcohol, ethylene oxide adduct of octyl phenol, ethylene oxide adduct of dodecyl phenol, ethylene oxide adduct of oleic acid, ethylene oxide adduct of lauric acid, ethylene oxide adduct of laurylamine, ethylene oxide adduct of stearylamine, ethylene oxide adduct of laurylic acid amide, ethylene oxide adduct of stearic acid amide, ethylene oxide adduct of oleic acid amide, etc.

(N) Alkylbetaine or alkylsulfobetaine having a hydrocarbon group having from 4 to 40, preferably from 10 to 20 carbon atoms. Specific examples of such a compound include lauryl dimethylbetaine, stearyl dimethylbetaine, dodecyl dimethyl(3-sulfopropyl)ammonium inner salt, cetyl dimethyl(3-sulfopropyl)ammonium inner salt, stearyl dimethyl(3-sulfopropyl)ammonium inner salt, 2-octyl-N-carboxymethyl-N-hydroxyethylimidazolinium betaine, 2-lauryl-N-carboxymethyl-N-hydroxyethylimidazolinium betaine, etc.

(P)N-alkyl-α-, 1- and γ-amino acid salt having an alkyl group having from 4 to 30, preferably from 10 to 20 carbon atoms on nitrogen atom. Specific examples of such a compound include laurylaminopropionic acid, cetylaminopropionic acid, stearylaminopropionic acid, and salt thereof, i.e., laurylaminopropionic acid salt, cetylaminopropionic acid salt, stearylaminopropionici acid salt, etc.

(Q) Ammonium compound having at least one hydrocarbon group having from 4 to 40, preferably from 10 to 30 carbon atoms. Specific examples of such a compound include ammonium such as lauryl trimethyl ammonium, cetyl dimethyl ammonium, cetyl benzyl dimethyl ammonium, stearyl trimethyl ammonium, lauryl benzyl dimethyl ammonium, dilauryl dimethyl ammonium, distearyl dimethyl ammonium, 2-(lauroylamino)ethyl trimethyl ammonium, 2-(stearoylamino)ethyl trimethyl ammonium, 2-(lauroylamino)ethyl dimethyl benzyl ammonium, 2-(stearoylamino)ethyl dimethyl benzyl ammonium, 2-(lauroylamino)ethyl diethyl methyl ammonium, 2-(stearoylamino)ethyl diethyl methyl ammonium, 2-(lauroylamino)ethyl diethyl benzyl ammonium, 2-(stearoylamino)ethyl diethyl benzyl ammonium, 3-(lauroylamino)propyl dimethyl-2-hydroxyethyl ammonium, -(stearoulamino)propyl dimethyl(2-hydroxyethyl)ammonium, lauryl dimethyl(2-hydroxyethoxy-2-ethyl) ammonium, stearyl dimethyl(2-hydroxyethoxy-2-ethyl) ammonium, stearyl dimethyl (2-hydroxyethoxy)-2-ethyl ammonium, 3-laurylaminopropyl dimethyl (2-hydroxyethyl)ammonium and 3-stearylamino-propyldimethyl(2-hydroxyethyl)ammonium, ammonium derived from laurylamine and coconut amine, chloride, bromide, hydroxide, methosulfate, ethosulfate, nitrate, sulfate and acetate of imidazolinium type quaternary ammonium, polyfimethyl diallyl ammonium, polymethyl diallyl ammonium, polydiallyl ammonium, dimethyl diallyl ammonium-acrylamide copolymer, methyl diallyl ammonium-acrylamide copolymer, diallyl ammonium-acrylamide copolymer, etc.

Preferred among these compounds are sodium salt or potassium salt of dodecanesulfonic acid, sodium salt or potassium salt of di(2-ethylhexyl)sulfosuccinate, sodium salt or potassium salt of dodecylbenzenesulfonic acid, lauryl dimethylbetaine, dodecyldimethyl(3-sulfopropyl)ammonium inner salt, lauryl trimethyl ammonium chloride, 3-(lauroylamino)propyldimethyl(2-hydroxyethyl)ammonium methosulfate, and dodecyl dimethyl benzyl ammonium chloride.

Further, these hydrophilicizers may be used in combination with a hydrophilicizing aid (R) so far as the effect thereof cannot be impaired. The amount of the hydrophilicizing aid (R) is not greater than 30% by weight, preferably not greater than 20% by weight based on 100% by weight of the sum of the amount of the hydrophilicizer and the hydrophilicizing aid. Specific examples of the hydrophilicizing aid (R) include higher aliphatic acid amide compound and higher alcohol having from 4 to 40 carbon atoms. Specific examples of these compounds include stearic acid amide, ethylene bisstearic acid amide, N-methylstearic acid amide, N-ethylstearic acid amide, oleic acid amide, behenic acid amide, lauroyl monoethanolamide, stearoyl mono ethanol amide, lauryl diethanolamine, stearyl diethanolamine, lauryl alcohol, stearyl alcohol, etc.

Referring to preferred proportion of components constituting the porous resin film of the present invention, the sum of the amount of the thermoplastic resin and the hydrophilicizer is from 30 to 90% by weight and the amount of the inorganic finely divided powder and/or organic finely divided powder is from 10 to 70% by weight.

The sum of the amount of the thermoplastic resin and the hydrophilicizer is more preferably from 30 to 65% by weight, even more preferably from 35 to 60% by weight. From the standpoint of further enhancement of the strength of the porous resin film, it is not smaller than 30 parts by weight, and in order to further enhance the absorption of aqueous solvent or ink, it is not greater than 90% by weight.

The amount of the inorganic finely divided powder and/or organic filler is by way of example from 10 to 70% by weight. The amount of the inorganic finely divided powder is preferably from 35 to 70% by weight, more preferably from 40 to 65% by weight. In order to increase pores, it is preferred that the amount of the finely divided powder be greater.

However, from the standpoint of enhancement of the surface strength of the porous resin film to a higher level, the amount of the finely divided powder is preferably not greater than 70% by weight. Most organic finely divided powders have a small specific gravity The amount of the organic finely divided powder is preferably from 10 to 50% by weight, more preferably from 15 to 40's by weight.

The amount of the hydrophilicizer to be used varies with the purpose of the porous resin film of the present invention. In practice, however, the amount of the hydrophilicizer to be used is from 0.01 to 50 parts by weight, preferably from 0.1 to 35 parts by weight, more preferably from 1 to 30 parts by weight based on 100 parts by weight of the thermoplastic resin. From the standpoint of enhancement of absorption of aqueous solvent or aqueous ink, the amount of the hydrophilicizer to be used is preferably not smaller than 0.01 parts by weight. When the amount of the hydrophilicizer to be used exceeds 50 parts by weight, the effect of the hydrophilicizer reaches the upper limit. Accordingly, in order to make smooth operation in the mixing or melt kneading with the thermoplastic resin and the inorganic or organic finely divided powder without troubles such as agglomeration and maldispersion, the amount of the hydrophilicizer is preferably not greater than 50 parts by weight.

When these finely divided powders are kneaded with the thermoplastic resin, a dispersant, an oxidation inhibitor, a compatibilizer, a fire retardant, an ultraviolet stabilizer, a coloring pigment, etc. may be added as necessary. Further, in the case where the porous resin film of the present invention is used as a durable material, an oxidation inhibitor, ultraviolet stabilizer, etc. are preferably added. Moreover, in the case where an organic finely divided powder is used, the kind and added amount of the compatibilizer are important because they determine the particle shape of the finely divided powder. Preferred examples of the compatibilizer include epoxy-modified polyolefin and maleic acid-modified polyolefin The added amount of the compatibilizer is preferably from 0.5 to 10 parts by weight based on 100 parts by weight of the organic finely divided powder.

The porous resin film of the present invention may comprise a hydrophilic resin incorporated therein as an arbitrary additional component in addition to the aforementioned components so far as the effect of the present invention cannot be impaired.

The hydrophilic resin is not specifically limited so far as it is dissolved in or swells with water and becomes plastic at a temperature of not lower than ordinary temperature.

For example, polyvinyl-based resins such as polyvinyl alcohol, copolymer or crosslinked material thereof, polyvinyl pyrrolidone and copolymer thereof as synthetic resins, polyacrylic resins and salt thereof (e.g., sodium salt, potassium salt, lithium salt, primary to quaternary ammonium salt) such as polymer or copolymer of acrylic acid, methacrylic acid or maleic acid containing a hydroxyalkyl group such as 2-hydroxyethyl and 2-hydroxypropyl group or crosslinking product thereof, polyacrylamide or copolymer thereof, hydrolyzate of polymer or crosslinking product of acrylonitrile and polymer or copolymer of acrylic acid or methacrylic acid or crosslinking product thereof, resins or salt thereof (e.g., sodium salt, potassium salt, lithium salt, primary to quaternary ammonium salt) such as polymaleic acid or maleic acid copolymer or crosslinking product thereof, hydrolyzate of copolymer of vinyl acetate and methyl methacrylate, water-soluble nylon, urethane-based resin, i.e., water-soluble polyurethane, high water absorption polyurethane, thermoplastic polyurethane, polyalkylene oxide-based resins such as polyethylene oxide or copolymer thereof and polypropylene oxide or copolymer thereof, polyether amide, polyether ester amide, polyester polyol, polyvinylamine, polyallylamine or copolymer thereof, etc. may be used. Alternatively, the hydrophilic resin can be selected from those described in references such as “Kobunshi Kako”, No. 9, 1984, pp. 32-38.

Among these hydrophilic resins, the polyalkylene oxide-based resins, which becomes plastic at a temperature of not lower than ordinary temperature and can be relatively easily formed into film, are preferably used.

Examples of the polyalkylene oxide-based resins include a polyalkylene oxide-based resin having an ester group obtained by the reaction of an alkylene oxide polymer having a weight-average molecular weight of from 5,000 to 30,000 obtained by the addition polymerization of an organic compound having two or more active hydrogen atoms such as ethylene glycol, diethylene glycol, propylene glycol, dipropylene glycol and 1, 4-butanediol with an alkylene oxide having from 2 to 6 with a polyvalent carboxylic acid having from 4 to 30 carbon atoms or lower dimethyl or diethyl ester thereof, a polyalkylene oxide having an urethane bond, a polyalkylene oxide having a carbonic acid ester bond, a polyalkylene oxide having an amide bond, a polyalkylene oxide containing urea or thiourea bond, etc.

As a method for mixing the components constituting the porous resin film of the present invention there may be used various methods. Thus, the method mixing the components constituting the porous resin film of the present invention is not specifically limited. The mixing temperature and time are properly predetermined according to the properties of the components used. Examples of the mixing method include a method which comprises mixing the components while being dissolved or dispersed in a solvent, and a melt-kneading method. The melt-kneading method gives a good production efficiency. A method which comprises mixing a thermoplastic resin in the form of powder or pellet, an inorganic finely divided powder or organic finely divided powder and a hydrophilicizer in a Henschel mixer, ribbon blender, super mixer or the like, melt-kneading the mixture in a single-screw or twin-screw kneader, extruding the mixture into a strand form, and then cutting the strand to form pellets or a method which comprises extruding the mixture into water, and then cutting the material with a rotary blade mounted on the forward end of the die may be employed. Alternatively, a method which comprises mixing a hydrophilicizer in the form of powder, liquid or solution in water or organic solvent with a thermoplastic resin and an inorganic finely divided powder or organic finely divided powder, and then mixing the mixture with other components maybe employed. As the single-screw or twin-screw kneader to be used there may, be selected one having various L/D (axial length/axial diameter) ratios, shearing speeds, specific energies, retention times, temperatures, etc. according to the properties of the components used.

The porous resin film and recording medium of the present invention can be prepared by using various methods known to those skilled in the art in combination. Any porous resin film or recording medium prepared by these known methods can be included in the scope of the present invention so far as it comprises a porous resin film satisfying the requirements of the present invention.

As a method for preparing a porous resin film of the present invention having a liquid absorption capacity of not smaller than 0.5 ml/m² there may be used any of various film preparation techniques or a combination thereof. For example, a film stretching method utilizing the formation of pores by stretching, a rolling method or calendering method involving the formation of pores during rolling, a foaming method using a foaming agent, a method using pore-containing particles, a solvent extraction method, a method involving dissolution and extraction of mixed components, etc. may be used. Preferred among these methods is the film stretching method.

In the case where the film stretching method is employed, it is not necessarily required that only the porous resin film of the present invention be stretched. For example, in the case where it is tried to finally prepare a (laminated) recording medium having the porous resin film of the present invention formed on a substrate layer, an unstretched porous resin film and a substrate layer may be laminated, and then together stretched. When these layers are previously laminated before combined stretching, it gives simplicity and reduced cost as compared with the case where these layers are separately stretched before being laminated. Further, this method makes it easier to control the pores formed in the porous resin film of the present invention and the substrate layer. In particular, in the case where the laminate is used as a recording medium, it is preferably controlled such that the porous resin film has more pores than the substrate layer to effectively act as a layer capable of improving ink absorbency.

The thermoplastic resin film forming the substrate layer may have a single layer structure, a two-layer structure consisting of a core layer and a surface layer, a three-layer structure comprising a surface layer provided on the both surfaces of a core layer or a multi-layer structure comprising other resin film layers interposed between the core layer and -the surface layer and may be stretched at least monoaxially. In the case where the multi-layer structure film is stretched, the three-layer structure film may be stretched monoaxially at all three layers, stretched monoaxially both at the surface layer and the core layer and biaxially at the back layer, stretched monoaxially at the surface layer, biaxially at the core layer and monoaxially at the back layer, stretched biaxially at the surface layer and monoaxially both at the core layer and the back layer, stretched monoaxially at the surface layer and biaxially both at the core layer and the back layer, stretched biaxially both at the surface layer and the core layer and monoaxially at the back layer or stretched biaxially at all three layers. In the case of a structure having more layers, the number of stretching axes is arbitrarily combined.

As the thermoplastic resin, inorganic finely divided powder and organic finely divided powder to be used in the substrate layer there may be used materials similar to those used in the aforementioned porous resin film.

In the case where the thermoplastic resin layer is a single-layer polyolefin-based resin film comprising an inorganic and/or organic finely divided powder incorporated therein, the thermoplastic resin film layer normally comprises a polyolefin-based resin and an inorganic and/or organic finely divided powder in an amount of from 40 to 99.5% by weight and from 0.5 to 60% by weight, preferably from 50 to 97% by weight and from 3 to 50% by weight, respectively.

In the case where the thermoplastic resin film has a multi-layer structure and the core layer and surface layer comprise an inorganic and/or organic finely divided powder incorporated therein, the core layer normally comprises a polyolefin-based resin and an inorganic and/or organic finely divided powder incorporated therein in an amount of from 40 to 99.5% by weight and from 0.5 to 60% by weight, preferably from 50 to 97% by weight and from 3 to 50% by weight, respectively, and the surface layer normally comprises a polyolefin-based resin and an inorganic and/or organic finely divided powder incorporated therein in an amount of from 25 to 100% by weight and from 0 to 75% by weight, preferably from 30 to 97% by weight and from 3 to 70% by weight, respectively.

When the amount of the inorganic and/or organic finely divided powder to be incorporated in the core layer having a single-layer or multi-layer structure exceeds 60% by weight, the resin film which has been longitudinally stretched can easily break during crosswise stretching. When the amount of the inorganic and/or organic finely divided powder to be incorporated in the surface layer exceeds 75% by weight, the surface layer which has been crosswise stretched has a lowered surface strength and the surface layer can easily break due to mechanical in use to disadvantage.

For the stretching, various known methods can be employed. The stretching can be effected at a temperature of not lower than the glass transition point of the thermoplastic resin used in the case of amorphous resin or at a temperature suitable for thermoplastic resin from not lower than the glass transition point of the amorphous portion to not higher than the melting point of the amorphous portion in the case of crystalline resin. In some detail, the stretching can be accomplished by longitudinal stretching utilizing the difference in circumferential speed between rolls, rolling, crosswise stretching using a tenter oven, inflation stretching using a mandrel on tube-like film, simultaneous biaxial stretching using a tenter oven and a linear motor in combination or the like.

The draw ratio is not specifically limited and is properly predetermined taking into account the purpose of the porous resin film of the present invention and the properties of the thermoplastic resin. For example, in the case where as the thermoplastic resin there is used a propylene homopolymer or copolymer thereof, the draw ratio is from about 1.2 to 12, preferably from 2 to 10 for monoaxial stretching or from 1.5 to 60, preferably from 10 to 50 as calculated in terms of area for biaxial stretching. In the case where other thermoplastic resins are used, the draw ratio is from 1.2 to 10, preferably 2 to 7 for monoaxial stretching or from 1.5 to 20, preferably from 4 to 12 as calculated in terms of area for biaxial stretching.

Further, the film may be subjected to heat treatment at a high temperature as necessary. The stretching temperature is from 2 to 60° lower than the melting point of the thermoplastic resin used, and the stretching ratio is preferably from 20 to 350 m/min.

The thickness of the porous resin film of the present invention is not specifically limited. For example, it may be adjusted to a range of from 5 μm to 400 μm, preferably from 30 μm to 200 μm.

The porous resin film of the present invention can be used as it is or maybe laminated on another thermoplastic resin, laminated paper, pulp paper, nonwoven cloth, cloth, etc. before use. Examples of the another thermoplastic resin film on which the porous resin film of the present invention is laminated include transparent or opaque films such as polyester film, polyamide film and polyolefin film. In particular, a proper functional layer as described in the examples below can be formed on the porous resin film of the present invention to form a recording medium. For example, the porous resin film of the present invention can be formed as a surface layer on a substrate layer made of a thermoplastic resin film to prepare a recording medium. The recording medium comprising the porous resin film of the present invention provided as a surface layer is useful particularly as a recording medium for ink jet recording. The kind of the substrate layer is not specifically limited, but a film comprising a polypropylene-based resin and an inorganic finely divided powder incorporated therein may be exemplified.

The recording medium thus formed by laminating the porous resin film of the present invention with other films may have a total thickness of, e.g., from 50 μm to 1 mm.

The aforementioned porous resin film or a laminate comprising the same maybe subjected to surface oxidation treatment as necessary. There are some cases where surface oxidation treatment makes it possible to enhance the hydrophilicity or absorbency of the surface of the film or enhance the coatability of the film with an ink-fixing agent or ink-receptive layer or the adhesivity of the film with the substrate. As the surface oxidation treatment there may be used one selected from corona discharge treatment, flame treatment, plasma treatment, glow discharge treatment and ozone treatment, preferably corona treatment or flame treatment, more preferably corona treatment.

The amount of treatment is from 600 to 12,000 J/m² (10 to 200 W·min/m²), preferably 1,200 to 9,000 J/m² (20 to 180 W·min/m²) in the case of corona treatment. In order to sufficiently exert the effect of corona discharge treatment, it is not smaller than 600 J/m² (10 W·min/m²). When the amount of treatment exceeds 12,000 J/m² (200 W·min/m²), the effect of treatment reaches the upper limit. Thus, the amount of treatment suffices if it is not greater than 12,000 J/m² (200 W·min/m²). The amount of treatment is from 8,000 to 200,000 J/m², preferably from 20,000 to 100,000 J/m² in the case of flame treatment. In order to exert a definite effect of flame treatment, the amount of treatment is not smaller than 8,000 J/m². When the amount of treatment exceeds 200,000 J/m², the effect of treatment reaches the upper limit. Thus, the amount of treatment suffices if it is not greater than 200, 000 J/m².

In the case where the porous resin film of the present invention is used as a recording medium, the porous resin film of the present invention may have a colorant-fixing layer for fixing a dye or pigment colorant or an ink-receptive layer formed on the surface thereof. The combination of such a colorant-fixing layer or ink-receptive layer with the porous resin film of the present invention having a good absorption of aqueous solvent makes it possible to reduce the occurrence of running, enhance the absorbency and reduce the thickness of the ink-receptive layer.

The ink-receptive layer acts to round ink dot, thereby providing a sharper image as well as preventing the flow of colorant due to water or moisture. Accordingly, in the case where the porous resin film of the present invention is used as an ink jet recording medium, the ink-receptive layer is particularly useful.

In the present invention, an ink-receptive layer is provided to obtain water resistance in addition to ink absorbency. Preferably, an ink-receptive layer having a surface gloss (as measured at 60° according to JIS Z-8741) of not smaller than 40% is provided to obtain a high gloss.

The ink-receptive layer may have either a single-layer structure or a multi-layer structure consisting of two or more layers. In the case of multi-layer structure, the various layers may have different or same formulation. In order to form a multi-layer structure, two or more layers may be coated at once or successively.

The ink-receptive layer comprises an inorganic filler having an average particle diameter of not greater than 350 nm and a binder resin incorporated therein in an amount of from 70 to 95% by weight and from 5 to 30% by weight, respectively, for the purpose of enhancing ink absorbency and realizing a high gloss.

When an inorganic filler having an average particle diameter of not smaller than 350 nm is used, the resulting ink-receptive layer exhibits a drastically lowered surface gloss to disadvantage.

Examples of the inorganic filler to be used in the present invention include colloidal silica, colloidal calcium carbonate, aluminum oxide, amorphous silica, pearl necklace-like colloidal silica, fibrous aluminum oxide, tabular aluminum oxide, alumina, alumina hydrate, etc.

Preferred among the aforementioned inorganic fillers is amorphous silica from the standpoint of ink jet printing ink absorbency or because of low cost. Preferred among the aforementioned inorganic fillers is alumina or alumina hydrate because it has a positive charge on the surface of particle to fix the ink jet printing ink fairly.

In particular, in order to obtain a high gloss ink-receptive layer, an amorphous silica obtained by agglomerating primary particles having an average diameter of from 1 to 10 nm is preferred.

An amorphous silica comprises agglomerated primary particles having an average diameter of from 1 to 50 nm. An amorphous silica having a primary particle diameter of from 1 to 10 nm is preferably used to enhance ink absorbency.

When an amorphous silica having a primary particle diameter of not greater than 10 nm is used in the ink-receptive layer, the resulting ink-receptive layer exhibits a drastic deterioration of gloss and ink absorbency to disadvantage. The reason why an amorphous silica falling within the scope of the present invention exhibits a high performance is unknown. However, this is presumably because the amorphous silica having a primary particle diameter of from 1 to 10 nm has a high gloss as well as has an increased gap between primary particles and hence an enhanced ink absorbency.

Processes for preparing amorphous silica can be roughly divided into two groups, i.e., dry process and wet process. In the present invention, silica prepared by any process can be used so far as it is an amorphous silica having a primary particle diameter of from 1 to 10 nm and an average particle diameter of not greater than 350 nm.

Alternatively, in the present invention, an amorphous silica having an average particle diameter of not greater than 350 nm obtained by crushing a commercially available amorphous silica having an average particle diameter of from 2 to 10 μm can be used. The method for crushing amorphous silica is not specifically limited. However, mechanical grinding using a grinder is preferably employed from the standpoint of uniformity in quality and because it allows grinding at a reduced cost. Specific examples of the grinder include ultrasonic grinding, jet mill, sand grinder, roller mill, high speed rotary mill, etc.

Further, the amorphous silica to be used in the present invention is preferably subjected to cationic treatment on the surface thereof to enhance the fixability of an ink jet printing ink, which is anionic.

Cationic treatment is treatment for covering the surface of silica with a cationic chemical during grinding or preparation of silica. Examples of such a cationic chemical include inorganic metal salt, cationic coupling agent, cationic polymer, etc.

Specific examples of the inorganic metal salt include hydrate of inorganic metal oxide such as aluminum oxide hydrate, zirconium oxide hydrate and tin oxide hydrate, water-soluble inorganic metal salt such as aluminum hydroxide, aluminum sulfate, aluminum chloride, aluminum acetate, aluminum nitrate, zirconium sulfate, zirconium chloride and tin chloride, etc.

Specific examples of the cationic coupling agent include cationic silane coupling agent such as amino group-containing silane coupling agent and quaternary ammonium group-containing silane coupling agent, cationic zirconium coupling agent such as amino group-containing zirconium coupling agent and quaternary ammonium group-containing zirconium coupling agent, cationic titanium coupling agent such as amino group-containing titanium coupling agent and quaternary ammonium group-containing titanium coupling agent, and cationic glycidyl coupling agent such as amino group-containing glycidyl coupling agent and quaternary ammonium group-containing glycidyl coupling agent.

Specific examples of the cationic polymer include polyalkylene polyamine such as polyethyleneimine and polypropylene polyamine, derivative thereof, amino group-containing acrylic polymer, quaternary ammonium group-containing acrylic polymer, amino group-containing polyvinyl alcohol, quaternary ammonium group-containing polyvinyl alcohol, etc. The average particle diameter and primary particle diameter of the inorganic filler to be used in the ink-receptive layer of the present invention can be measured by the same apparatus as used in the measurement of the inorganic finely divided powder or organic finely divided powder in the aforementioned porous substrate.

Specific examples of alumina include α-alumina, β-alumina, γ-alumina, δ-alumina, η-alumina, θ-alumina, etc. From the standpoint of ink absorbency and gloss, δ-alumina is preferred.

Specific examples of the alumina hydrate include alumina hydrate having a pseudo-boehmite structure (pseudo-boehmite), alumina hydrate having an amorphous structure (amorphous alumina hydrate), etc. Pseudo-boehmite is preferred from the standpoint of ink absorbency and gloss.

In the ink-receptive layer of the present invention, a binder resin is used as an adhesive.

In the present invention, the ink-receptive layer comprises a binder resin incorporated therein as an adhesive in addition to the inorganic filler. Referring to the mixing proportion of inorganic filler and binder resin, the proportion of the organic filler and the binder resin are preferably from 70 to 95% by weight and from 5 to 30% by weight, respectively.

When the proportion of the inorganic filler exceeds 95% by weight, the resulting ink-receptive layer exhibits a drastically reduced adhesivity to the porous resin film. On the contrary, when the proportion of the inorganic filler falls below 70% by weight, the resulting ink-receptive layer exhibits a drastically reduced ink absorbency.

Specific examples of the binder resin employable herein include water-soluble resins such as polyvinyl alcohol, derivative thereof, polyvinyl pyrrolidone, polyacrylamide, hydroxyethyl cellulose, casein and starch, and water-insoluble resins such as urethane-based resin, ester-based resin, epoxy-based resin, ethylene-based resin, ethylene-vinyl acetate copolymer resin, vinyl acetate-based resin, vinyl chloride-based resin, vinyl chloride-vinyl acetate-based copolymer resin, vinylidene chloride-based resin, vinyl chloride-vinylidene copolymer resin, acrylic acid-based resin, methacrylic acid-based resin, polybutyral-based resin, silicon resin, nitrocellulose resin, styrene-acryl copolymer resin, styrene-butadiene-based copolymer resin and acrylonitrile-butadiene-based copolymer resin. The aforementioned water-soluble resin may be used in the form of aqueous solution and the aforementioned water-insoluble resin may be used in the form of solution, emulsion or latex.

Preferred among the aforementioned binder resins is polyvinyl alcohol from the standpoint of compatibility with the inorganic filler or ink absorbency. In particular, from the standpoint of strength of coat film, a polyvinyl alcohol having a polymerization degree of not smaller than 3,000 and a saponification degree of from 80% to 95% is preferred. In the present invention, a crosslinking agent is preferably used in an amount: of from 1 to 20% by weight based on the amount of the ink-receptive layer to enhance the water resistance of the binder resin. Specific examples of the crosslinking agent include urea-formaldehyde resin, melamine-formaldehyde resin, polyamide polyurea-formaldehyde resin, glyoxal, epoxy-based crosslinking agent, polyisocyanate resin, boric acid, borax, various borates, etc.

In addition, in the present invention, the ink-receptive layer preferably comprises an ink-fixing agent incorporated therein in an amount of from 1 to 20% by weight based on the amount of the ink-receptive layer to improve the ink fixability. Examples of the ink-fixing agent include inorganic metal salt, cationic coupling agent, cationic polymer, etc.

Specific examples of the inorganic metal salt, cationic coupling agent and cationic polymer include those described with reference to cationic chemical to be used in the cationic treatment of the aforementioned amorphous silica.

The ink-receptive layer of the present invention may also comprise various auxiliaries such as dispersant, thickening agent, antifoaming agent, preservative, ultraviolet absorber, oxidation inhibitor and surface active agent which are normally used in coated paper as necessary.

The coated amount of the ink-receptive layer of the present invention is properly predetermined according to the liquid absorption capacity of the porous resin film used as a support but is preferably from 5 to 30 g/m². When the coated amount of the ink-receptive layer falls below 5 g/m², the resulting ink-receptive layer lacks gloss, oozing properties and water resistance. On the contrary, when the coated amount of the ink-receptive layer exceeds 30 g/m², the resulting ink-receptive layer exhibits a satisfactory ink absorbency but exhibits a deteriorated surface strength.

In the present invention, for the purpose of improving gloss and surface fretting abrasion resistance, it is preferred that a top coat layer having a gloss (as measured at 60° according to JIS Z-8741) of not smaller than 50% be provided on the ink-receptive layer.

The top coat layer of the present invention preferably comprises an inorganic filler and a binder resin incorporated therein in an amount of from 70 to 95% by weight and from 5 to 30% by weight, respectively. As the inorganic filler and binder resin there may be used the same filler and binder as the inorganic filler and binder resin used in the ink-receptive layer.

Further, the top coat layer preferably comprises a cationic ink-fixing agent incorporated therein in an amount of from 1 to 20% by weight for the purpose of enhancing ink fixability. As the ink-fixing agent there may be used the same fixing agent, as the ink-fixing agent used in the aforementioned ink-receptive layer.

The coated amount of the top coat layer of the present invention is properly predetermined according to the porous resin film or ink-receptive layer but is from 0.1 to 5.0 g/m², preferably from 0.5 to 3.0 g/m². When the coated amount of the top coat layer falls below 0.1 g/m², the effect of the top coat layer cannot be sufficiently exerted. On the contrary, when the coated amount of the top coat layer exceeds 5.0 g/m², the effect of the top coat layer is saturated.

The top coat layer of the present invention may comprise various auxiliaries such as dispersant, thickening agent, antifoaming agent, preservative, ultraviolet absorber, oxidation inhibitor and surface active agent which are normally used in coated paper as necessary.

The method for coating the aforementioned ink-receptive layer and top coat layer on the porous resin film can be properly selected from known methods. Examples of the coating method include blade coating method, rod bar coating method, roll coating method, air knife coating method, spray coating method, gravure coating method, curtain coating method, die coating method, comma coating method, etc.

The porous resin film of the present invention may be subjected to printing other than ink jet printing depending on the purpose. The kind and process of printing are not specifically limited. For example, printing can be accomplished by a known printing method such as gravure printing using an ink having a pigment dispersed in a known vehicle, aqueous flexographic printing, silk screen printing, melt heat transfer printing and sublimation heat transfer printing. Alternatively, printing can be accomplished by metallization, gloss printing, mat printing or the like. The pattern to be printed may be properly selected from natural pattern such as animal, scenery, lattice and polka dots and abstract pattern.

The porous resin film of the present invention may also be used for purposes requiring the absorption of aqueous liquid other than printing purposes. For example, the porous resin film of the present invention can be used as adhesive label comprising an aqueous adhesive, label paper to be stuck on vessels such as bottle and can, water-absorbing film, wall paper, surface decorative paper for veneer board and plasterboard, film for preventing the production of water drop, drip preventive wrapping paper for food, coaster, paper for working, colored paper used for making figures by folding, water-retaining sheet, soil drying preventive sheet, concrete drying aid material, drying agent, dehumidifier or the like.

The present invention will be further described hereinafter in the following examples, comparative examples and test examples. Proper changes can be made in the materials, added amount, proportion, operation, etc. described in the following examples so far as they do not depart from the spirit of the present invention. Accordingly, the scope of the present invention is not limited to the specific examples described hereinafter.

Porous resin films of the present invention, recording media comprising same and recording media comprising comparative resin films were prepared according to the following procedures.

### EXAMPLE 1

A propylene homopolymer (abbreviation: PP1) having a melt flow rate (MFR; temperature: 230° C.; load: 2.16 kg), a calcium carbonate powder (average particle diameter: 2 μm; abbreviation: Tankaru (representing a Japanese abbreviation for calcium carbonate) 1), and a hydrophilicizer (mixture of 95% of sodium dodecanesulfonate and 5% of amide ethylenebisstearate; surface tension as measured in its 0.01% aqueous solution according to Du-Nouy method; abbreviation: HP 1) were mixed in the form of powder in an amount of 45% by weight (100 parts by weight), 50% by weight and 5% by weight (11 parts by weight based on 100 parts by weight of propylene homopolymer), respectively, melt-kneaded in a twin-screw kneader which had been set to 230° C., extruded into strands, and then cut to form pellets. During melt kneading, 4-methyl-2,6-di-t-butylphenol as an oxidation inhibitor and Irganox 1010 (trade name, produced by Ciba Geigy Inc.) were added in an amount of 0.1 parts by weight and 0.05 parts by weight, respectively, based on 100 parts by weight of the total weight of the propylene homopolymer, calcium carbonate powder and hydrophilicizer.

The particle diameter of the calcium carbonate powder used in the examples of the specification is 50% cumulative particle diameter measured by a laser diffraction type particle measuring instrument “Microtrack” (trade name, produced by NIKKISO CO., LTD.).

The aforementioned pellets were melted in a press molding machine which had been set to 230° C., compressed at 50 kgf/cm², and then cooled to a temperature of 30° C. to obtain a sheet having a length of 120 mm, a width of 120 mm and a thickness of about 1 mm. The density of the sheet was 1.4 g/cm³.

The sheet was heated to a temperature of 150° C. (temperature al) in a biaxial stretching machine (produced by Iwamoto Seisakujo K.K.), stretched at a draw ratio of 6 in one direction, and then cooled by cool air to a temperature of 90° C. (temperature b1) to obtain a porous resin film having a thickness of 330 μm, a basis weight of 182 g/m² and a density (ρ) of 0.55 g/cm³.

The porous resin film thus obtained was then evaluated in the following manner.

(1) Liquid Absorption Capacity

The aforementioned porous resin film exhibited a liquid absorption capacity of 19 ml/m² at 2 seconds. The liquid absorption capacity was measured by means of a liquid absorbency testing machine produced by Kumagai Riki Kogyo K. K. according to “Japan TAPPI No. 51-87” (JAPAN TAPPI, paper pulp testing method No. 51-87; Bristow Method). The measurement solvent was obtained by mixing 70% by weight of water and 30% by weight of ethylene glycol, and then dissolving malachite green in the mixed solvent in an amount of 2 parts by weight based on 100 parts by weight of the mixed solvent.

(2) Average Contact Angle of Porous Resin Film with Respect to Water and Difference Between Maximum Value and Minimum Value Thereof

The contact angle of the surface of the aforementioned porous resin film was determined by dropping purified water onto the surface of the film, and then measuring the surface of the film for contact angle by means of a contact angle meter (Type CA-D, produced by KYOWA INTERFACE SCIENCE CORPORATION LIMITED) after 1 minute. This measurement was effected 10-times (the specimen was replaced by an unmeasured film which had not been wet with purified water every measurement), and the average value of the ten measurements of contact angle and the difference between the maximum value and the minimum value of contact angle were then determined.

(3) Confirmation of Presence of Surface Pores and Measurement of Number and Dimension of Surface Pores

The aforementioned porous resin film was cut to sample a portion out of the film to confirm that pores were present in the surface and section of the film. An arbitrary portion was cut out of the porous resin film sample. The sample was then vacuum-metallized with gold or gold-palladium on the surface to be observed. The sample was then observed at a magnification power of 500 under a Type S-2400 scanning electron microscope produced by Hitachi Ltd. to confirm the presence of pores in the surface of the film. Further, the electron microscope image was outputted onto paper or taken in photograph on which the number of pores in the surface of the film was then counted. As a result, the number, of pores was about 7×10⁹/m². Subsequently, the size of pores in the surface was measured. The size of 20 pores were averaged. As a result, the major axis was 15.4 μm, the minor axis was 3.2 μm, and the average diameter was 9.3 μm. In the case where two pores are connected to both sides of a finely divided particle or upper and lower sides of a finely divided particle, respectively, the two pores were collectively regarded as a pore assuming that pores are formed with the finely divided particle as a center.

(4) Confirmation of Presence of Internal Pores and Measurement of Internal Porosity

The porous resin film was embedded in an epoxy resin which was then solidified, cut by a microtome so that sections were formed in the direction parallel to the thickness direction and in the direction perpendicular to the surface of the film, respectively, metallized with gold-palladium on the sections, and then observed on the sections at a magnification power of 2,000 to confirm the presence of internal pores.

The drawing obtained by smearing away the pores on the area thus observed was then image-processed by an image analyzer (LUZEX IID, produced by NIRECO CORPORATION) to determine the percent area of pores from which the porosity was then calculated.

(5) Ink Absorbency

A color chart for evaluation (50% printed monochromatic color and 100% printed monochromatic color on 2 cm×2 cm area, 200% printed polychromatic color on 2 cm×2 cm area) was prepared, and printing was then made on the various recording media on its porous resin film as surface layer with pigment inks (yellow, magenta, cyan, black) using an ink jet printer (Type JP2115, produced by GRAPHTEC CORPORATION). Thereafter, a filter paper was pressed onto the printed area at a predetermined interval of time to observe to see if the ink returned to the filter paper. The time at which the ink no longer returns to the filter paper was recorded. The ink absorbency was then evaluated according to the following criterion.

6: Time in which the ink no longer returns to the filter paper is shortly after printing;

5: Time in which the ink no longer returns to the filter paper is not more than 1 minute;

4: Time in which the ink no longer returns to the filter paper is from more than 1 minute to not more than 2 minutes;

3: Time in which the ink no longer returns to the filter paper is from more than 2 minutes to not more than 3 minutes;

2: Time in which the ink no longer returns to the filter paper is from more than 3 minutes to not more than 4 minutes;

1: Time in which the ink no longer returns to the filter paper is from more than 4 minutes to not more than 5 minutes; and

0: The ink still returns to the filter paper and doesn't dry even after more than 5 minutes

The porous resin film which had absorbed the ink was visually observed for density unevenness, and then evaluated according to the following criterion.

4: No density unevenness;

3: Little density unevenness;

2: Some density unevenness; and

1: Remarkable density unevenness

The porous resin film which had absorbed the ink was visually observed for running, and then evaluated according to the following criterion.

4: No running, sharp image;

3: Little running, little difficulty in recognition of image;

2: Some running, some difficulty in recognition of image; and

1: Remarkable running, disabled to use

The porous resin film on which printing had been made was allowed to stand in a room for 1 hour, visually observed for the occurrence of surface unevenness (roughness), and then evaluated according to the following criterion.

3: No unevenness, flat surface, little or no change from before printing;

2: Little unevenness; and

1: Remarkable unevenness

The aforementioned various tests and results of evaluation are together set forth in Table 1.

The printed sample which had been prepared under the same conditions as in the aforementioned evaluation of ink absorbency was dipped in a sufficient amount of tap water (temperature: 25° C.) for 4 hours, air-dried on the surface thereof, visually observed for the degree of ink retention, and then evaluated according to the following criterion.

3: Percent ink retention is from 805 to 100%;

2: Percent ink retention is from 50% to 80%; and

1: Percent ink retention is from 0% to 50%

### Comparative Example 1

A resin film was prepared in the same manner as in Example 1 except that no hydrophilicizer was used and the formulation was as set forth in Table 1. The resin film was then evaluated in the same manner as in Example 1.

The results are set forth in Table 1.

TABLE 1

| | | | | Comparative | | |
|---|---|---|---|---|---|---|
| | | Unit | Example 1 | Example 1 | Example 2 | Example 3 |
| Formulation | <Thermoplastic resin> | | | | | |
| | Kind | — | PP1 | PP1 | PP1 | PP1 |
| | Amount | wt-%/wt-% | 45/100 | 50/100 | 45/100 | 45/100 |
| | <Thermoplastic resin> | | | | | |
| | Kind | — | — | — | — | PEP01 |
| | Amount | wt-%/wt-% | — | — | — | 3/7 |
| | <Finely divided powder> | | | | | |
| | Kind of finely divided powder 1 | — | Tankaru 1 | Tankaru 1 | Tankaru 1 | Tankaru 1 |
| | Particle diameter of finely divided powder 1 | μm | 2 | 2 | 2 | 2 |
| | Specific surface area of finely divided powder | m²/g | 2.2 | 2.2 | 2.2 | 2.2 |
| | 1 | | | | | |
| | Amount of finely divided powder 1 | wt-% | 50 | 50 | 50 | 50 |
| | <Hydrophilicizer> | | | | | |
| | Kind of hydrophilicizer | — | HP1 | — | HP1 | HP1 |
| | Amount of hydrophilicizer | wt-%/parts | 5/11 | — | 5/11 | 2/4 |
| | | by wt. | | | | |
| Forming | Temperature a1 | ° C. | 160 | 160 | 162 | 160 |
| conditions | Temperature b1 | ° C. | 90 | 90 | 90 | 90 |
| | Draw ratio | Times | 6 | 6 | 6 longi. | 6 |
| | | | | | 6 cross. | |
| Results of | Thickness of porous resin film layer | μm | 330 | 240 | 178 | 360 |
| evaluation of film | Liquid absorption capacity (2 seconds) | ml/m² | 19 | 0 | 17 | 25 |
| | Average contact angle of surface with water | ° | 0 | 115 | 20 | 0 |
| | Difference between maximum value and | ° | 0 | 2 | 8 | 0 |
| | minimum value of contact angle with water | | | | | |
| | Inter porosity | % | 60 | 32 | 58 | 65 |
| | Number of pores in surface | /m² | 7E + 9 | 3.6E + 10 | 9.5E + 8 | 8E + 9 |
| | Average diameter of pores in surface | μm | 9 | 2 | 6 | 6 |
| | Ink dryability (monochromatic 50%) | Visually | 6 | 0 | 6 | 6 |
| | | observed | | | | |
| | Ink dryability (monochromatic 100%) | Visually | 6 | 0 | 6 | 6 |
| | | observed | | | | |
| | Ink dryability (polychromatic 200%) | Visually | 6 | 0 | 6 | 6 |
| | | observed | | | | |
| | Density unevenness | Visually | 4 | 1 | 4 | 4 |
| | | observed | | | | |
| | Running | Visually | 3 | 1 | 3 | 3 |
| | | observed | | | | |
| | Surface unevenness after printing | Visually | 3 | 3 | 3 | 3 |
| | | observed | | | | |

### Example 2

A biaxially stretched film was prepared in the same manner as in Example 1 except that the stretching by a small-sized biaxial stretching machine involved stretching at a draw ratio of 6 both in the longitudinal and crosswise directions at a temperature of 162° C. The biaxially stretched film was then evaluated in the same manner as in Example 1.

### Example 3

A resin film was prepared in the same manner as in Example 1 except that a polyalkylene oxide-based resin (copolymer. of about 90% of ethylene oxide and about 10% of butylene oxide; abbreviation: PEPO1) was added to Example 1 and the formulation was as set forth in Table 1. The resin film was then evaluated in the same manner as in Example 1. The results are set forth in Table 1.

### Example 4

A composition [a]obtained by adding 20% by weight of calcium carbonate having an average particle diameter of 3 μm to a mixture of 75% by weight of a propylene homopolymer having a melt flow rate (MFR: 230° C., 2.16 kg load) of 1 g/10 minutes and 5% by weight of a high density polyethylene having a melt flow rate (MFR: 190° C., 2.16 kg load) was kneaded in an extruder which had been set at a temperature of 250° C., extruded into strands, and then cut to prepare pellets. The composition [a]was extruded through a T-die connected to the extruder which had been set at a temperature of 250° C. into a sheet which was then cooled by a cooling apparatus to obtain an unstretched sheet. Subsequently, the unstretched sheet was heated to a temperature of 140° C., and then stretched at a draw ratio of 4.5 in the longitudinal direction to obtain a stretched sheet.

In the melt kneading of the resin component or the, mixture thereof with the finely divided powder in the present example, BHT (4-methyl-2,6-di-t-butylphenol) and Irganox 1010 (trade name of phenol-based oxidation inhibitor produced by Ciba Geigy Inc.) were added to the resin component and the finely divided powder in an amount of 0.2 parts by weight and 0.1 parts by weight, respectively, based on 100 parts by weight of the total weight of the resin component and the finely divided powder.

Separately, 46% by weight of a propylene homopolymer (abbreviation: PP2) having MFR of 5 g/10 minutes, 50% by weight of calcium carbonate (abbreviation: tankaru 2) having an average particle diameter of 3 μm, a specific surface area of 1.8 m²/g as determined by BET method and an oil absorption of 31 ml/100 g as measured according to JIS-K5101-1991 and 4% by weight of HP1 described above as a hydrophilicizer were thoroughly mixed in the form of powder, and then extruded through a biaxial kneader which had been set at a temperature of 240° C. into strands which were then cut to prepare pellets (composition [b]).

This composition was then extruded through a T-die connected to the extruder which had been set at a temperature of 230° C. (temperature a) into a sheet. The sheet thus obtained was then laminated on both surfaces of the sheet which had been stretched at a draw ratio of 4.5 in the aforementioned manner, cooled at a temperature of 50° C. (temperature b), and then stretched at a draw ratio of 8 in the crosswise direction by means of a tenter at an elevated temperature of 154° C. (temperature c). Thereafter, the laminate was annealed at a temperature of 155° C. (temperature d), cooled to a temperature of 55° C. (temperature e), and then slit at the edge thereof to obtain a laminate comprising a porous resin film having a total thickness of 136 μm having a three-layer structure (surface absorption layer [b]/substrate layer [a]/back absorption layer [b]: thickness 69 μm/40 μm/27 μm).

The laminate of the present example was then evaluated on the surface absorption layer. The results are set forth in Table 2.

### Comparative Example 2

A film was prepared in the same manner as in Example 1 except that the amount of the thermoplastic resin (PP2) was 60% by weight, as the finely divided powder there was used 60% by weight of: tankaru 1 and no hydrophilicizer was added. The film was then evaluated. The results are set forth in Table 2.

### Examples 5 to 7

Laminates having a porous resin film were obtained in the same manner as in Example 3 except that the composition ratio of propylene homopolymer, calcium carbonate and hydrophilicizer in the formation of surface porous resin film was as set forth in Table 2 and the temperatures a to e were as set forth in Table 2. These laminates were then evaluated in the same manner as in Example 1. The results are set forth in Table 2.

### Examples 8, 9

Porous resin films were obtained in the same manner as in Example 4 except that the composition ratio of propylene homopolymer, finely divided powder and hydrophilicizer in the formation of surface porous resin film was as set forth in Table 2 and the temperatures a to a were as set forth in Table 2. These porous resin films were then evaluated in the same manner as in Example 1.

As the finely divided powders there were used, in addition to “tankaru 2” used in Example 4, calcium carbonate produced by K. K. Shiraishi Kenkyujo (trade name: Callite-KT: average particle diameter: about 2,m; BET specific surface area: 38 m²/g; oil absorption as measured according to JIS-K5101-1991:140 ml/100 g (abbreviation: tankaru 3)) and silica produced by Fuji Silysia Chemical Ltd. (trade name: Silysia 730; average particle diameter: about 3 μm; BET specific surface area: 700 m²/g; oil absorption as measured according to JIS-K5101-1991:95 ml/100 g (abbreviation: silica 1)).

The results are set forth in Table 2.

TABLE 2

| | | | | Comparative | | | | | |
|---|---|---|---|---|---|---|---|---|---|
| | | Unit | Example 4 | Example 2 | Example 5 | Example 6 | Example 7 | Example 8 | Example 9 |
| Formulation | <Thermoplastic resin> | | | | | | | | |
| | Kind | — | PP2 | PP2 | PP2 | PP2 | PP2 | PP2 | PP2 |
| | Amount | wt-%/wt-% | 45/100 | 50 | 40/100 | 47/100 | 37/100 | 48/100 | 48/100 |
| | <Finely divided powder> | | | | | | | | |
| | Kind of finely divided | — | Tankaru 2 | Tankaru 2 | Tankaru 2 | Tankaru 2 | Tankaru 2 | Tankaru 2 | Tankaru 2 |
| | powder 1 | | | | | | | | |
| | Particle diameter of finely | μm | 3 | 3 | 3 | 3 | 3 | 3 | 3 |
| | divided powder 1 | | | | | | | | |
| | Specific surface area of | m²/g | 1.8 | 1.8 | 1.8 | 1.8 | 1.8 | 1.8 | 1.8 |
| | finely divided powder 1 | | | | | | | | |
| | Amount of finely divided | wt-% | 50 | 50 | 50 | 50 | 58 | 47 | 47 |
| | powder 1 | | | | | | | | |
| | Kind of finely divided | — | — | — | — | — | — | Tankaru 3 | Tankaru 3 |
| | powder 2 | | | | | | | | |
| | Particle diameter of finely | μm | — | — | — | — | — | approx. 2 | 3 |
| | divided powder 2 | | | | | | | | |
| | Specific surface area of | m²/g | — | — | — | — | — | 38 | 700 |
| | finely divided powder 2 | | | | | | | | |
| | Amount of finely divided | wt-% | — | — | — | — | — | 5 | 5 |
| | powder 2 | | | | | | | | |
| | <Hydrophilicizer> | | | | | | | | |
| | Kind of hydrophilicizer | — | HP1 | — | HP1 | HP1 | HP | HP1 | HP1 |
| | Amount of hydrophilicizer | wt-%/parts | 4/9 | — | 10/25 | 3/6 | 5/14 | 4/8 | 4/8 |
| | | by wt. | | | | | | | |
| Forming | Temperature a | ° C. | 230 | 230 | 230 | 230 | 230 | 230 | 230 |
| conditions | Temperature b | ° C. | 50 | 50 | 50 | 50 | 50 | 50 | 50 |
| | Temperature c | ° C. | 154 | 154 | 154 | 154 | 155 | 154 | 154 |
| | Temperature d | ° C. | 155 | 155 | 155 | 155 | 156 | 155 | 155 |
| | Temperature e | ° C. | 55 | 55 | 55 | 55 | 55 | 55 | 55 |
| | Kind of surface oxidation | — | — | — | — | — | — | — | — |
| | treatment | | | | | | | | |
| | Intensity of surface | J/m³ | — | — | — | — | — | — | — |
| | oxidation treatment | | | | | | | | |
| Results of | Total thickness of film | μm | 136 | 140 | 140 | 127 | 143 | 136 | 140 |
| evaluation | Thickness of porous resin | μm | 69 | 65 | 72 | 60 | 66 | 58 | 61 |
| of film | film | | | | | | | | |
| | Thickness of substrate layer | μm | 40 | 40 | 38 | 35 | 40 | 39 | 40 |
| | Liquid absorption capacity | ml/m² | 7 | 0 | 7.5 | 5.9 | 7 | 5.7 | 6 |
| | (2 seconds) | | | | | | | | |
| | Surface gloss | % | 27 | 17 | 29 | 24 | 29 | 25 | 27 |
| | Average contact angle of | ° | 82 | 116 | 20 | 86 | 85 | 88 | 86 |
| | surface with water | | | | | | | | |
| | Difference between | ° | 2 | 5 | 2 | 3 | 4 | 5 | 6 |
| | maximum value and | | | | | | | | |
| | minimum value of contact | | | | | | | | |
| | angle with water | | | | | | | | |
| | Inter porosity | % | 63 | 52 | 64 | 58 | 64 | 60 | 62 |
| | Number of pores in surface | /m² | 5.9E + 8 | 3.1E + 9 | 9E + 8 | 5.4E + 8 | 7.5E + 8 | 9.5E + 8 | 9E + 8 |
| | Average diameter of pores | μm | 13 | 7 | 12 | 12 | 11 | 8 | 7 |
| | in surface | | | | | | | | |
| | Ink dryability | Visually | 6 | 0 | 6 | 6 | 6 | 6 | 6 |
| | (monochromatic 50%) | observed | | | | | | | |
| | Ink dryability | Visually | 6 | 0 | 6 | 6 | 6 | 6 | 6 |
| | (monochromatic 100%) | observed | | | | | | | |
| | Ink dryability | Visually | 6 | 0 | 6 | 5 | 6 | 6 | 6 |
| | (polychromatic 200%) | observed | | | | | | | |
| | Density unevenness | Visually | 4 | 1 | 4 | 4 | 4 | 4 | 4 |
| | | observed | | | | | | | |
| | Running | Visually | 4 | 1 | 4 | 4 | 4 | 4 | 4 |
| | | observed | | | | | | | |
| | Surface unevenness after | Visually | 3 | 3 | 3 | 3 | 3 | 3 | 3 |
| | printing | observed | | | | | | | |

### Examples 10 to 15

Resin films were obtained in the same manner as in Example 4 except that the kind and composition ratio of propylene homopolymer, calcium carbonate and hydrophilicizer in the formation of surface porous resin film were as set forth in Table 3 and the temperatures a to e were as set forth in Table 2. These resin films were then evaluated in the same manner as in Example 1. The results of evaluation are set forth in Table 3.

The hydrophilicizer used in Example 10 was sodium dodecanesulfonate (reagent grade, produced by Wako Pure Chemical Industries, Ltd.) the surface tension of which is 43 mN/m (abbreviation: HP2) in its 0.01% aqueous solution.

The hydrophilicizer used in Example 11 was sodium dodecylbenzenesulfonate (reagent grade, produced by Wako Pure Chemical Industries, Ltd.) the surface tension of which is 43 mN/m (aobreviation: HP3) in its 0.01% aqueous solution.

The hydrophilicizer used in Example 12 was Pellex NB paste comprising as a main component sodium alkylnaphthalenesulfonate (trade name, produced by Kao Corp.) the surface tension of which is 59 mN/m (abbreviation: HP4) in its 0.01% aqueous solution.

The hydrophilicizer used in Example 13 was sodium di-2-ethylhexylsulfosuccinate (reagent grade, produced by Aldrich Inc.) the surface tension of which is 43.5 mN/m (abbreviation: HP5) in its 0.01% aqueous solution.

The hydrophilicizer used in Example 14 was dodecyl dimethyl(3-sulfopropyl)ammonium inner salt (reagent grade, produced by Aldrich Inc.) the surface tension of which is 54.3 mN/m (abbreviation: HP6) in its 0.01% aqueous solution.

The hydrophilicizer used in Example 15 was Coatamine 24P (mainly composed of lauryl trimethyl ammonium chloride, trade name, produced by Kao Corp.) the surface tension of which is 53.8 mN/m (abbreviation: HP7) in its 0.01% aqueous solution.

### Example 16

A laminate having a porous resin film as a surface layer was obtained in-the same-manner as in Example 4 except that the composition ratio of propylene homopolymer, tankaru 2 and hydrophilicizer was as set forth in Table 3. The laminate was then subjected to corona treatment on the surface thereof at a density of 3,600 J·m² (60 W·min/m²).

The laminate was then evaluated in the same manner as in Example 1. The results of evaluation are set forth in Table 3.

TABLE 3

| | | | | Example | | Example | | Example | |
|---|---|---|---|---|---|---|---|---|---|
| | | Unit | Example 10 | 11 | Example 12 | 13 | Example 14 | 15 | Example 16 |
| Formulation | <Thermoplastic resin> | | | | | | | | |
| | Kind | — | PP2 | PP2 | PP2 | PP2 | PP2 | PP2 | PP2 |
| | Amount | wt-%/wt-% | 46/100 | 46/100 | 40/100 | 40/100 | 40/100 | 40/100 | 45.5/100 |
| | <Finely divided powder> | | | | | | | | |
| | Kind of finely divided | — | Tankaru 2 | Tankaru 2 | Tankaru 2 | Tankaru 2 | Tankaru 2 | Tankaru 2 | Tankaru 2 |
| | powder 1 | | | | | | | | |
| | Particle diameter of finely | μm | 3 | 3 | 3 | 3 | 3 | 3 | 3 |
| | divided powder 1 | | | | | | | | |
| | Specific surface area of | m²/g | 1.8 | 1.8 | 1.8 | 1.8 | 1.8 | 1.8 | 1.8 |
| | finely divided powder 1 | | | | | | | | |
| | Amount of finely divided | wt-% | 50 | 50 | 50 | 50 | 50 | 50 | 50 |
| | powder 1 | | | | | | | | |
| | Kind of finely divided | — | — | — | — | — | — | — | — |
| | powder 2 | | | | | | | | |
| | Particle diameter of finely | μm | — | — | — | — | — | — | — |
| | divided powder 2 | | | | | | | | |
| | Specific surface area of | m²/g | — | — | — | — | — | — | — |
| | finely divided powder 2 | | | | | | | | |
| | Amount of finely divided | wt-% | — | — | — | — | — | — | — |
| | powder 2 | | | | | | | | |
| | <Hydrophilicizer> | | | | | | | | |
| | Kind of hydrophilicizer | — | HP2 | HP3 | HP4 | HP5 | HP6 | HP7 | HP1 |
| | Amount of hydrophilicizer | wt-%/parts | 4/9 | 4/9 | 4/9 | 4/9 | 4/9 | 4/9 | 2.5/5 |
| | | by wt. | | | | | | | |
| Forming | Temperature a | ° C. | 230 | 230 | 230 | 230 | 230 | 230 | 230 |
| conditions | Temperature b | ° C. | 50 | 50 | 50 | 50 | 50 | 50 | 50 |
| | Temperature c | ° C. | 154 | 154 | 154 | 154 | 154 | 154 | 154 |
| | Temperature d | ° C. | 155 | 155 | 155 | 155 | 155 | 155 | 155 |
| | Temperature e | ° C. | 55 | 55 | 55 | 55 | 55 | 55 | 55 |
| | Kind of surface oxidation | — | — | — | — | — | — | — | Corona |
| | treatment | | | | | | | | treatment |
| | Intensity of surface | J/m³ | — | — | — | — | — | — | 3,600 |
| | oxidation treatment | | | | | | | | |
| Results of | Total thickness of film | μm | 135 | 139 | 134 | 143 | 141 | 144 | 137 |
| evaluation | Thickness of porous resin | μm | 63 | 60 | 57 | 64 | 63 | 65 | 62 |
| of film | film | | | | | | | | |
| | Thickness of substrate layer | μm | 38 | 41 | 40 | 38 | 37 | 38 | 33 |
| | Liquid absorption capacity | Ml/m² | 6.2 | 6.3 | 5.9 | 6.7 | 6.5 | 6.5 | 6 |
| | (2 seconds) | | | | | | | | |
| | Surface gloss | % | 24 | 25 | 26 | 24 | 23 | 24 | 22 |
| | Average contact angle of | ° | 78 | 75 | 80 | 76 | 76 | 76 | 20 |
| | surface with water | | | | | | | | |
| | Difference between | ° | 4 | 3 | 4 | 4 | 5 | 5 | 12 |
| | maximum value and | | | | | | | | |
| | minimum value of contact | | | | | | | | |
| | angle with water | | | | | | | | |
| | Inter porosity | % | 59 | 60 | 61 | 58 | 56 | 58 | 55 |
| | Number of pores in surface | /m² | 6.6E + 8 | 6.2E + 8 | 7E + 8 | 5.8E + 8 | 6E + 8 | 7.1E + 8 | 5.3 + 8 |
| | Average diameter of pores | μm | 13 | 14 | 12 | 13 | 13 | 12 | 13 |
| | in surface | | | | | | | | |
| | Ink dryability | Visually | 6 | 6 | 6 | 6 | 6 | 6 | 6 |
| | (monochromatic 50%) | observed | | | | | | | |
| | Ink dryability | Visually | 6 | 6 | 6 | 6 | 6 | 6 | 5 |
| | (monochromatic 100%) | observed | | | | | | | |
| | Ink dryability | Visually | 6 | 6 | 6 | 6 | 6 | 6 | 4 |
| | (polychromatic 200%) | observed | | | | | | | |
| | Density unevenness | Visually | 4 | 4 | 4 | 4 | 4 | 4 | 3 |
| | | observed | | | | | | | |
| | Running | Visually | 4 | 4 | 4 | 4 | 4 | 4 | 3 |
| | | observed | | | | | | | |
| | Surface unevenness after | Visually | 3 | 3 | 3 | 3 | 3 | 3 | 3 |
| | printing | observed | | | | | | | |

### Example 17

The porous resin film prepared in Example 14 was subjected to corona treatment at a density of 3,600 J/m2 (60 W·min/m²). Onto the porous resin film (on one surface thereof) was then coated a coating solution for ink-receptive layer having the following formulation in an amount of 5 g/m². The coated material was dried, and then subjected to smoothing by super calendering to obtain an ink jet recording paper.

Formulation of Coating Solution:

| | | |
|---|---|---|
| Synthetic silica powder (Mizukasil | 100 | parts by weight |
| P-78D, produced by MIZUSAWA INDUSTRIAL | | |
| CHEMICALS, LTD.) | | |
| Polyvinyl alcohol (PVA-117, produced by | 30 | parts by weight |
| KURARAY CO., LTD.) | | |
| Polyamine polyamide epichlorohydrin | 10 | parts by weight |
| adduct (WS-570, produced by JAPAN PMC | | |
| CORPORATION) | | |
| Sodium polyacrylate (reagent, produced by | 5 | parts by weight |
| Wako Pure Chemical Industries, Ltd.) | | |
| Water | 1,600 | parts by weight |

The ink jet recording paper was then evaluated in the same manner as in Example 1.

The results of evaluation are set forth in Table 4.

### Comparative Example 3

A commercially available pulp paper-based ink jet paper (Epson Superfine Paper MJA4SP1) was evaluated in the same manner as in Example 1. The results are set forth in Table 4.

TABLE 4

| | | | | Comparative |
|---|---|---|---|---|
| | | Unit | Example 17 | Example 3 |
| Substrate/ | Kind of substrate or | — | Example 4 | Pulp-based |
| support | support | | | paper |
| | Kind of surface | — | Corona | |
| | oxidation treatment | | treatment | |
| | Intensity of surface | J/m² | 3,600 | |
| | oxidation treatment | | | |
| | Liquid absorption | ml/m² | 7.2 | |
| | capacity of surface | | | |
| | oxidation treatment | | | |
| | Contact angle with | ° | 12 | |
| | water after surface | | | |
| | oxidation treatment | | | |
| | Difference between | ° | 7 | |
| | maximum value and | | | |
| | minimum value of | | | |
| | contact angle with | | | |
| | water after surface | | | |
| | oxidation treatment | | | |
| | Solid content of ink- | g/m² | 5 | |
| | receptive layer | | | |
| Results of | Ink dryability | Visually | 6 | 6 |
| evaluation | (monochromatic | observed | | |
| | 50%) | | | |
| | Ink dryability | Visually | 6 | 6 |
| | (monochromatic | observed | | |
| | 100%) | | | |
| | Ink dryability | Visually | 6 | 6 |
| | (polychromatic | observed | | |
| | 200%) | | | |
| | Density unevenness | Visually | 4 | 4 |
| | | observed | | |
| | Running | Visually | 4 | 4 |
| | | observed | | |
| | Surface unevenness | Visually | 3 | 1 |
| | after printing | observed | | |

### Examples 18 to 22, Comparative Examples 4 to 9

The materials set forth in Table 5 were used in predetermined amounts, and then processed in the following manner to prepare an ink jet recording sheet.

An amorphous silica, a binder resin, a crosslinking agent, an ink-fixing agent, and water were mixed to prepare a coating solution for forming an ink-receptive layer. The coating solution was applied to the surface of the porous resin film by means of a mayor bar in a dried amount of 15 g/m², and then dried and solidified in a 110° C. oven for 5 minutes to form a receptive layer, thereby obtaining an ink jet recording paper. The ink jet recording paper was then evaluated for adaptability to ink jet printer in the same manner as for the porous resin film.

The formulation and the results of evaluation of surface gloss and adaptability to ink jet recording are set forth in Table 6.

### Examples 23 to 25

The materials set forth in Table 5 were used in predetermined amounts, and then processed in the following manner to prepare an ink jet recording sheet.

An inorganic filler, a binder resin, an ink-fixing agent, and water were mixed to prepare a coating solution for top coat layer.

An ink-receptive layer was then formed on the porous resin film in the same manner as in Example 18. The coating solution for top coat layer was applied to the porous resin film by means of a mayor bar in a dried amount of 1.0 g/m², and then dried and solidified in a 110° C. oven for 1 minute to form a top coat layer, thereby obtaining an ink jet recording paper.

The formulation and the results of evaluation of surface gloss and adaptability to ink jet printer are set forth in Table 6.

TABLE 5

| Name of material | Contents |
|---|---|
| Amorphous silica 1 | Aqueous dispersion of particulate silica having a primary particle |
| | diameter of 7 nm and an average particle diameter of 300 nm |
| | obtained by grinding silica prepared by gel method (solid content: |
| | 20%) “Cyclojet 703A” (trade name, produced by Grace Japan Co., |
| | Ltd.) |
| Amorphous silica 2 | Aqueous dispersion of particulate silica having a primary particle |
| | diameter of 6 nm and an average particle diameter of 300 nm |
| | obtained by dispersing silica having an average particle diameter of |
| | 2.5 μm “Mizukasil P-73” (trade name, produced by prepared by |
| | MIZUSAWA CHEMICALS, LTD.) prepared by gel method (solid |
| | content: 10%) by a sand grinder |
| Amorphous silica 3 | Aqueous dispersion of particulate cationically-treated silica having |
| | a primary particle diameter of 7 nm and an average particle |
| | diameter of 300 nm obtained by grinding silica prepared by gel |
| | method (solid content: 18%) “Cyclojet 703C” (trade name, |
| | produced by Grace Japan Co., Ltd.) |
| Amorphous silica 4 | Aqueous dispersion of silica having a primary particle diameter of |
| | 7 nm and an average particle diameter of 100 nm obtained by |
| | dispersing silica “Aerosil 300CF” (Nippon Aerosil Co., Ltd.) |
| | prepared by gas phase method by a sand grinder (solid content: |
| | 8%) |
| Amorphous silica 5 | Aqueous dispersion of silica having a primary particle diameter of |
| | 6 nm and an average particle diameter of 800 nm obtained by |
| | dispersing silica “Mizukasil P-73” (MIZUSAWA INDUSTRIAL |
| | CHEMICALS, LTD.) having an average particle diameter of 2.5 |
| | μm prepared by gel method by a sand grinder (solid content: 10%) |
| Amorphous silica 6 | Aqueous dispersion of silica having a primary particle diameter of |
| | 25 nm and an average particle diameter of 300 nm obtained by |
| | dispersing silica “Mizukasil P-526” (MIZUSAWA INDUSTRIAL |
| | CHEMICALS, LTD.) having an average particle diameter of 3.0 |
| | μm prepared by precipitation method by a sand grinder (solid |
| | content: 10%) |
| Colloidal silica 1 | “Snowtechs YL” (trade name, produced by Nissan Chemical |
| | Industries, Ltd.), which is an aqueous dispersion of spherical |
| | colloidal silica having an average particle diameter of 70 nm (solid |
| | content: 40%) |
| Binder resin | Aqueous solution of “Kuraray Poval PVA-235” (trade name, |
| | KURARAY CORP.) (solid content: 10%), which is a polyvinyl |
| | alcohol having a polymerization degree of 3,500 and a |
| | saponification degree of 88% |
| Crosslinking agent 1 | Aqueous dispersion of a melamine-formaline resin (solid content: |
| | 80%) “Uramine P-6300” (trade name, produced by Mitsui |
| | Chemical Inc.) |
| Crosslinking agent 2 | 4% Aqueous dispersion of sodium tetraborate decahydrate (alias: |
| | borax, reagent grade, produced by Wako Pure Chemical Industries, |
| | Ltd.) |
| Ink-fixing agent 1 | Aqueous dispersion of cationic acryl polymer (solid content: 30%) |
| | “Sumirez Resin 1001” (trade name, produced by SUMITOMO |
| | CHEMICAL CO., LTD.) |
| Ink-fixing agent 2 | 10% Aqueous dispersion of aluminum chloride hexahydrate |
| | (reagent, produced by Wako Pure Chemical Industries, Ltd.) |

TABLE 6
(part 1)

| | | | Example 18 | Example 19 | Example 20 | Example 21 | Example 22 | Example 23 |
|---|---|---|---|---|---|---|---|---|
| Support | | | Example 4 | Example 4 | Example 4 | Example 4 | Example 4 | Example 4 |
| Ink-receptive | Amorphous silica 1 | | 76 | 76 | | | | 76 |
| layer | Amorphous silica 2 | | | | 76 | | | |
| | Amorphous silica 3 | | | | | 76 | | |
| | (cation) | | | | | | | |
| | Amorphous silica 4 | | | | | | 76 | |
| | Amorphous silica 5 | | | | | | | |
| | Amorphous silica 6 | | | | | | | |
| | Binder resin | | 20 | 20 | 20 | 20 | 20 | 20 |
| | Crosslinking agent 1 | | 2 | 2 | 2 | 2 | | 2 |
| | Crosslinking agent 2 | | | | | | 2 | |
| | Ink-fixing agent 1 | | 2 | | 2 | 2 | | 2 |
| | Ink-fixing agent 2 | | | 2 | | | 2 | |
| | Coated amount (g/m²) | | 15 | 15 | 15 | 15 | 15 | 15 |
| Top coat | Amorphous silica 1 | | | | | | | 90 |
| layer | Colloidal silica 1 | | | | | | | |
| | Binder resin | | | | | | | 10 |
| | Ink-fixing agent 2 | | | | | | | |
| Results of | Surface gloss (%) | | 45 | 46 | 45 | 42 | 44 | 55 |
| evaluation of | Ink | Visually | 6 | 6 | 6 | 6 | 6 | 6 |
| film | dryability | observed | | | | | | |
| | (polychro- | | | | | | | |
| | matic | | | | | | | |
| | 200%) | | | | | | | |
| | Density | Visually | 4 | 4 | 4 | 4 | 4 | 4 |
| | unevenness | observed | | | | | | |
| | Running | Visually | 4 | 4 | 4 | 4 | 4 | 4 |
| | | observed | | | | | | |
| | Water | Visually | 3 | 3 | 3 | 3 | 3 | 3 |
| | resistance | observed | | | | | | |
| | Surface | Visually | 3 | 3 | 3 | 3 | 3 | 3 |
| | unevenness | observed | | | | | | |
| | after | | | | | | | |
| | printing | | | | | | | |

(part 2)

| | | | | | Comparative | Comparative | Comparative | Comparative |
|---|---|---|---|---|---|---|---|---|
| | | | Example 24 | Example 25 | Example 4 | Example 5 | Example 6 | Example 7 |
| | | | Example | Example | Example | Comparative | Example | Example |
| Support | | | 4 | 4 | 4 | Example 2 | 4 | 4 |
| Ink-receptive | Amorphous silica 1 | | 76 | 76 | 80 | 76 | | |
| layer | Amorphous silica 2 | | | | | | | |
| | Amorphous silica 3 | | | | | | | |
| | (cation) | | | | | | | |
| | Amorphous silica 4 | | | | | | | |
| | Amorphous silica 5 | | | | | | 76 | |
| | Amorphous silica 6 | | | | | | | 76 |
| | Binder resin | | 20 | 20 | 20 | 20 | 20 | 20 |
| | Crosslinking agent 1 | | 2 | 2 | | 2 | 2 | 2 |
| | Crosslinking agent 2 | | | | | | | |
| | Ink-fixing agent 1 | | 2 | 2 | | 2 | 2 | 2 |
| | Ink-fixing agent 2 | | | | | | | |
| | Coated amount (g/m²) | | 15 | 15 | 15 | 15 | 15 | 15 |
| Top coat | Amorphous silica 1 | | | | | | | |
| layer | Colloidal silica 1 | | 90 | 80 | | | | |
| | Binder resin | | | | | | | |
| | Ink-fixing agent 2 | | | 10 | | | | |
| Results of | Surface gloss (%) | | 59 | 60 | 47 | 37 | 15 | 18 |
| evaluation of | Ink | Visually | 6 | 6 | 6 | 0 | 6 | 6 |
| film | dryability | observed | | | | | | |
| | (polychro- | | | | | | | |
| | matic | | | | | | | |
| | 200%) | | | | | | | |
| | Density | Visually | 4 | 4 | 4 | 1 | 4 | 4 |
| | unevenness | observed | | | | | | |
| | Running | Visually | 4 | 4 | 4 | 1 | 4 | 4 |
| | | observed | | | | | | |
| | Water | Visually | 3 | 3 | 1 | 1 | 1 | 1 |
| | resistance | observed | | | | | | |
| | Surface | Visually | 3 | 3 | 3 | 3 | 3 | 3 |
| | unevenness | observed | | | | | | |
| | after | | | | | | | |
| | printing | | | | | | | |

(part 3)

| | | | Comparative | Comparative |
|---|---|---|---|---|
| | | | Example 8 | Example 9 |
| Support | | | Example 4 | Example 4 |
| Ink-receptive | Amorphous silica 1 | | 60 | 97 |
| layer | Amorphous silica 2 | | | |
| | Amorphous silica 3 (cation) | | | |
| | Amorphous silica 4 | | | |
| | Amorphous silica 5 | | | |
| | Amorphous silica 6 | | | |
| | Binder resin | | 40 | 3 |
| | Crosslinking agent 1 | | | |
| | Crosslinking agent 2 | | | |
| | Ink-fixing agent 1 | | | |
| | Ink-fixing agent 2 | | | |
| | Coated amount (g/m²) | | 15 | 15 |
| Top coat | Amorphous silica 1 | | | |
| layer | Colloidal silica 1 | | | |
| | Binder resin | | | |
| | Ink-fixing agent 2 | | | |
| Results of | Surface gloss (%) | | 44 | 3 |
| evaluation of | Ink | Visually observed | 6 | 6 |
| film | dryability | | | |
| | (polychro- | | | |
| | matic | | | |
| | 200%) | | | |
| | Density | Visually observed | 4 | 4 |
| | unevenness | | | |
| | Running | Visually observed | 4 | 4 |
| | Water | Visually observed | 1 | 1 |
| | resistance | | | |
| | Surface | Visually observed | 3 | 3 |
| | unevenness | | | |
| | after | | | |
| | printing | | | |

### Examples 26 to 29, Comparative Examples 10 to 13

The materials set forth in Table 7 were used in predetermined amounts, and then processed in the following manner to prepare an ink jet recording sheet.

In some detail, alumina or alumina hydrate, and a binder resin were mixed to prepare a coating solution for forming an ink-receptive layer. The coating solution was applied to the surface of the porous resin film by means of a mayor bar in a dried amount of 15 g/m², and then dried and solidified in a 110° C. oven for 5 minutes to form a receptive layer, thereby obtaining an ink jet recording paper. The ink jet recording paper was then evaluated for adaptability to ink jet printer in the same manner as for the porous resin film.

The formulation and the results of evaluation of surface gloss and adaptability to ink jet recording are set forth in Table 8.

### Examples 30, 31

The materials set forth in Table 7 were used in predetermined amounts, and then processed in the following manner to prepare an ink jet recording sheet.

An ink-receptive layer was formed on the porous resin film in the same manner as in Example 26. An inorganic filler and a binder resin were mixed to prepare a coating solution for top coat layer. The coating solution for top coat layer was then applied to ink-receptive layer by means of a mayor bar in a dried amount of 1.0 g/m², and then dried and solidified in a 110° C. oven for 1 minute to form a top coat layer, thereby obtaining an ink jet recording paper.

The formulation and the results of evaluation of surface gloss and adaptability to ink jet printer are set forth in Table 8.

TABLE 7

| Name of material | Contents |
|---|---|
| Alumina 1 | Dispersion of “Alminium Oxide C” (trade name, produced by |
| | Nippon Aerosil Co., Ltd.), which is δ-alumina having an average |
| | particle diameter of 20 nm, in a 80/20 (by weight) mixture of |
| | water and isopropyl alcohol obtained by dispersion using a |
| | homogenizer and a Ultrasonic dispersing machine |
| Alumina 2 | Dispersion of “AKP3000” (trade name, produced by SUMITOMO |
| | CHEMICAL CORPORATION), which is α-alumina having an |
| | average particle diameter of 550 nm, in a 80/20 (by weight) |
| | mixture of water and isopropyl alcohol obtained by dispersion |
| | using a homogenizer and a ultrasonic dispersing machine |
| Alumina hydrate 1 | Aqueous dispersion of fibrous pseudo boehmite having an average |
| | particle diameter of 100 nm (solid content: 7%) (Cataloid AS-3) |
| | (produced by CATALYSTS & CHEMICALS IND. CO., LTD.) |
| Alumina hydrate 2 | Aqueous dispersion of fibrous pseudo boehmite having an average |
| | particle diameter of 25 nm (solid content: 10%) (Cataloid AS-2) |
| | (produced by CATALYSTS & CHEMICALS IND. CO., LTD.) |
| Binder resin 1 | Aqueous solution of “Kuraray Poval PVA-235” (trade name, |
| | KURARAY CORP.) (solid content: 10%), which is a polyvinyl |
| | alcohol having a polymerization degree of 3,500 and a |
| | saponification degree of 88% |
| Binder resin 2 | Aqueous solution of “Kuraray Poval PVA-124” (trade name, |
| | KURARAY CORP.) (SOLID CONTENT: 15%), which is a |
| | polyvinyl alcohol having a polymerization degree of 2,400 and a |
| | saponification degree of 95% |
| Colloidal silica 1 | “Snowtechs YL” (trade name, produced by Nissan Chemical |
| | Industries, Ltd.), which is an aqueous dispersion of spherical |
| | colloidal silica having an average particle diameter of 70 nm (solid |
| | content: 15%) |
| Colloidal silica 2 | “Snowtechs PL-M” (trade name, produced by Nissan Chemical |
| | Industries, Ltd.), which is an aqueous dispersion of pearl necklace- |
| | like colloidal silica having an average particle diameter of 150 nm |
| | (solid content: 20%) |

TABLE 8

| | | | Exam- | Exam- | Exam- | Exam- | Exam- | Exam- | Comparative | Comparative | Comparative | Comparative |
|---|---|---|---|---|---|---|---|---|---|---|---|---|
| | | | ple 26 | ple 27 | ple 28 | ple 29 | ple 30 | ple 31 | Example 10 | Example 11 | Example 12 | Example 13 |
| | | | Exam- | Exam- | Exam- | Exam- | Exam- | Exam- | Comparative | Exam- | Exam- | Exam- |
| Support | | | ple 4 | ple 4 | ple 4 | ple 4 | ple 4 | ple 4 | Example 2 | ple 4 | ple 4 | ple 4 |
| Ink- | Alumina 1 | | 80 | | | | | 80 | 80 | | 60 | 97 |
| receptive | Alumina 2 | | | | | | | | | 80 | | |
| layer | Alumina hydrate 1 | | | 90 | | | | | | | | |
| | Alumina hydrate 2 | | | | 90 | 90 | | | | | | |
| | Binder resin 1 | | 20 | 10 | 10 | | 20 | 20 | 20 | 20 | 40 | 3 |
| | Binder resin 2 | | | | | 10 | | | | | | |
| | Coated amount | | 15 | 15 | 15 | 15 | 15 | 15 | 15 | 15 | 15 | 15 |
| | (g/m²) | | | | | | | | | | | |
| Top coat | Colloidal silica 1 | | | | | | 90 | | | | | |
| layer | Colloidal silica 2 | | | | | | | 90 | | | | |
| | Binder resin 1 | | | | | | 10 | 10 | | | | |
| Results of | Surface gloss (%) | | 49 | 52 | 55 | 53 | 63 | 62 | 38 | 15 | 51 | 46 |
| evaluation | Ink | Visually | 6 | 6 | 6 | 6 | 6 | 6 | 0 | 6 | 6 | 6 |
| of film | dryability | ob- | | | | | | | | | | |
| | (polychro- | served | | | | | | | | | | |
| | matic | | | | | | | | | | | |
| | 200%) | | | | | | | | | | | |
| | Density | Visually | 4 | 4 | 4 | 4 | 4 | 4 | 1 | 4 | 4 | 4 |
| | unevenness | ob- | | | | | | | | | | |
| | | served | | | | | | | | | | |
| | Running | Visually | 4 | 4 | 4 | 4 | 4 | 4 | 1 | 4 | 4 | 4 |
| | | ob- | | | | | | | | | | |
| | | served | | | | | | | | | | |
| | Water | Visually | 3 | 3 | 3 | 3 | 3 | 3 | 1 | 1 | 1 | 1 |
| | resistance | ob- | | | | | | | | | | |
| | | served | | | | | | | | | | |
| | Surface | Visually | 3 | 3 | 3 | 3 | 3 | 3 | 3 | 3 | 3 | 3 |
| | unevenness | ob- | | | | | | | | | | |
| | after | served | | | | | | | | | | |
| | printing | | | | | | | | | | | |

As can be seen in Tables 1 to 8, the porous resin film of the present invention (Examples 1 to 16) exhibits little density unevenness and a very good ink absorbency even if the amount of ink is great. Further, in the case where an ink-receptive layer comprising the inorganic filler and binder of the present invention is provided on the porous resin film (Examples 17 to 22, 26 to 29), the porous resin film exhibits a good ink absorbency and a good running resistance, demonstrating that the effect of the present can be definitely exerted. Further, the provision of a top coat layer on the ink-receptive layer (Examples 23 to 25, 30, 31) causes enhancement of surface gloss.

On the contrary, all the films having a liquid absorption capacity deviating from the scope of the present invention (Comparative Examples 1, 2) exhibit a deteriorated ink absorbency. Further, the comparison of the examples with the comparative examples shows that the porous resin film of the present invention exhibits no surface unevenness after printing, demonstrating that the effect of the present can be definitely exerted. Further, the ink jet recording paper comprising a porous resin film deviating from the scope of the present invention (Comparative Examples 5, 10) and the ink jet recording paper comprising an ink-receptive layer deviating from the scope of the present invention (Comparative Examples 4, 6 to 9, 11 to 13) cannot meet the aforementioned requirements and thus exhibit deteriorated performance.

The porous resin film of the present invention exhibits an extremely good absorption of aqueous solvent and ink. Further, the recording medium of the present invention comprising the aforementioned porous resin film can forma fine image free of density unevenness thereon even if the ejected amount of ink is great. Accordingly, the porous resin film and recording medium of the present invention can be preferably provided for a wide printing purpose such as recording with an aqueous ink, particularly ink jet recording medium, or purpose using an aqueous solvent.

Japanese applications JP 2000-069740, JP 2000-156093 and JP11-342129 filed on Mar. 14, 2000, May 26, 2002 and Dec. 1, 1999, and PCT application PCT/JP00/08435 filed on Nov. 29, 2000 are each incorporated herein in their entirety. Obviously, numerous modifications and variations of the present invention are possible in light of the above teachings. It is therefore to be understood that within the scope of the appended claims, the invention may be practiced otherwise than as specifically described herein.

1. A porous resin film comprising a thermoplastic resin, an inorganic and/or organic finely divided powder and a hydrophilicizer, wherein said porous resin film has a liquid absorption capacity of not smaller than 0.5 m/m² as measured by “Japan TAPPI No. 51-87”.

2. The porous resin film of claim 1, which has an average contact angle of not greater than 110° with respect to water.

3. The porous resin film of claim 1, which has a porosity of not smaller than 10%.

4. The porous resin film of claim 1, wherein the thermoplastic resin is a polyolefin-based resin.

5. The porous resin film of claim 1, wherein the average particle diameter of the inorganic finely divided powder or organic finely divided powder is from 0.01 μm to 20 μm.

6. The porous resin film of claim 1, wherein the specific surface area of the inorganic finely divided powder or organic finely divided powder is not smaller than 0.5 m² μg.

7. The porous resin film of claim 1, wherein the hydrophilicizer has a surface tension of not smaller than 25 mN/m as measured as a 0.01% aqueous solution.

8. The porous resin film of claim 7, wherein the hydrophilicizer is a sodium or potassium salt of sulfonic acid having a C₄-C₄₀ hydrocarbon group, an alkyl betain having a C₄-C₃₀ hydrocarbon group, alkyl sulfobetain having a C₄-C₃₀ hydrocarbon group, or an ammonium compound having at least one C₄-C₄₀ hydrocarbon group.

9. The porous resin film of claim 7, wherein the sum of the amount of the thermoplastic resin and the hydrophilicizer is from 30 to 90% by weight, the amount of the inorganic and/or organic finely divided powder is from 10 to 70% by weight, and the amount of the hydrophilicizer based on 100 parts by weight of the thermoplastic resin is from 0.01 to 50 parts by weight.

10. The porous resin film of claim 1, which is stretched.

11. The porous resin film of claim 1, which is subjected to oxidation on a surface thereof.

12. A laminate comprising the porous resin film of claim 1 on at least one surface.

13. A recording medium comprising the porous resin film of claim 1.

14. An ink jet recording medium comprising the porous resin film of claim 1.

15. An ink jet recording medium comprising an ink-receptive layer on at least one surface of the porous resin film of claim 14.

16. The ink jet recording medium of claim 15, wherein the ink-receptive layer has a surface gloss of not smaller than 40% measured at 60° according to JIS-Z8741.

17. The ink jet recording medium of claim 15, wherein the ink-receptive layer comprises an inorganic filler having an average particle diameter of not greater than 350 nm in an amount of from 70 to 95% by weight, and a binder resin in an amount from 5 to 30% by weight.

18. The ink jet recording medium of claim 17, wherein the inorganic filler comprises one selected from the group consisting of amorphous silica, alumina and alumina hydrate.

19. The ink jet recording medium of claim 18, wherein the amorphous silica is obtained by agglomerating a plurality of primary particles having an average diameter of from 1 nm to 10 nm.

20. The ink jet recording medium of claim 18, wherein the amorphous silica is a cationically treated silica.

21. The inkjet recording medium of claim 18, wherein the alumina is δ-alumina.

22. The ink jet recording medium of claim 18, wherein the alumina hydrate is pseudo-boehmite.

23. The ink jet recording medium of claim 15, wherein the ink-receptive layer comprises a crosslinking agent and an ink fixing agent each in amounts of from 1 to 20% by weight.

24. The ink jet recording medium of claim 15, further comprising a top coat layer on the ink-receptive layer having a surface gloss of not smaller than 50% measured at 60° according to JIS-Z8741.

25. The ink jet recording medium of claim 24, wherein the top coat layer comprises an inorganic filler having an average particle diameter of not greater than 350 nm in an amount of 70 to 95% by weight and a binder resin in an amount of from 5 to 30% by weight.

26. The ink jet recording medium of claim 24, wherein the top coat layer comprises an ink fixing agent in an amount of from 1 to 20% by weight.
